(19) United States
(12) Patent Application Publication
(10) Pub. No.: US 2010/0066662 A1
(43) Pub. Date: Mar. 18, 2010

(54) IMAGE DISPLAY DEVICE

(75) Inventors: Isao Tomisawa, Tokorozawa-shi (JP); Masaru Ishikawa, Tokorozawa-shi (JP); Katsumi Unehara, Tokorozawa-shi (JP); Takehiro Takahashi, Tokorozawa-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/443,747

(22) PCT Filed: Oct. 2, 2006
(86) PCT No.: PCT/JP2006/319706

§ 371 Date: Apr. 24, 2009

(51) Int. Cl. G09G 5/00; G02B 27/22

(52) U.S. Cl. 345/156; 353/10

(57) ABSTRACT

An image display device makes it possible to easily display a stereoscopically two-dimensional image and to improve its direction effect. A display device includes a first display for displaying a first image on a first screen, an image transmission element that is set in a light path for a display light component of the first image and that transmits the display light component of the first image so that a real image of the first image is displayed on an image forming surface positioned at a space on a side opposite to the first screen as a stray image. Further, the display device includes a. controller for controlling the first display so that at least one icon out of a plurality of icons (A-H) is displayed as a stray image disposed along a virtual path with a predetermined shape set in a real space portion including the first mentioned space.

### TECHNICAL FIELD

The present invention relates to an image display apparatus for stereoscopically displaying a two-dimensional image on the basis of a 3D (Dimension) floating vision method, for example.

### BACKGROUND ART

This type of stereoscopic two-dimensional image can improve a realistic sensation, visibility, amusement, and the like in interior decorations, promotion displays, communication terminal apparatuses, game equipment, and the like. Hence, various methods for displaying the stereoscopic two-dimensional image have been suggested. For example, a polarization method is suggested in which a viewer wears polarized glasses and views right and left parallax images based on mutually different polarization states. However, this method may cause such a problem that it is bothersome for the viewer to wear the polarized glasses.

In order to deal with the problem, for example, a lenticular lens method has been suggested as a stereoscopic image display method which does not use the polarized glasses (e.g. refer to a patent document 1). According to this method, a plurality of screens are hidden in one screen, and the plurality of screens are shown through a transmissive screen, obtained by connecting semicircular-column-type lenses of a certain width in a horizontal direction, to thereby realize stereoscopic representation and motion-picture representation.

Alternatively, the 3D floating vision method has been suggested by the present inventors (e.g. refer to a patent document 2). According to this method, by providing a two-dimensional image as a real image by a microlens array, it is possible to display a stereoscopic two-dimensional image in a relatively simple structure.

Patent Document 1: Japanese Patent Application Laid Open No. Hei 10-221644

Patent Document 2: Japanese Patent Application Laid Open No. 2005-234240

### DISCLOSURE OF INVENTION

### Subject to be Solved by the Invention

However, for example, in the technology disclosed in the patent document 1, there is the following problem in terms of cost; namely, in the aforementioned lenticular lens method, the plurality of screens are hidden in one screen, and therefore, it requires the parallax images corresponding to the both eyes of the viewer from the imaging stage. Moreover, in order to supply the images, many operations are required: for example, computer image processing, lenticular lens designing, and an operation of accurately combining the lenses and the images. This causes high cost.

Alternatively, according to the technology disclosed in the aforementioned patent document 2, although the problem in terms of cost associated with the patent document 1 can be solved, there is room for improvement in rendering effect. In particular, in cases where a plurality of icons are displayed using the two-dimensional images, simply disposing them randomly provides a possibility to lack in the rendering effect.

In view of the aforementioned problems, it is therefore an object of the present invention to provide an image display apparatus which displays a stereoscopic two-dimensional image, relatively easily, and which can improve its rendering effect

### Means for Solving the Subject

The above object of the present invention can be achieved by an image display apparatus provided with: a first displaying device for displaying a first image on a first screen; an image transmitting device which is disposed on an optical path of display light which constitutes the first image and which transmits the display light which constitutes the first image so as to display a real image of the first image as a floating image on an image formation surface located in a space on an opposite side to the first screen; and a controlling device for controlling the first displaying device such that at least one of a plurality of icons is displayed as a floating image disposed along a virtual route in a predetermined shape set in a real space portion including the space.

According to the present invention, firstly, the first image is displayed on the first screen by the first displaying device such as a color liquid crystal display apparatus.

Here, the image transmitting device including, for example, a microlens array is disposed on the optical path of the display light which constitutes the first image. By this image transmitting device, the display light which constitutes the first image is transmitted and displayed as the floating image on the image formation surface which is located in the space on the opposite side to the first screen. The “floating image” herein is an image which looks as if it were floating in the air from a user located at the observation position (i.e. in the range of user's view angle), and it is preferably the real image. For example, it includes such an image display method as a 3D floating vision (registered trade mark of the present inventors) method or an integral photography method.

By the way, in cases where the floating image displayed in the above manner is used to display the plurality of icons, randomly disposing the icons is rarely useful for the use of the floating image, and there is a possibility to lack in the rendering effect.

According to the present invention, however, the virtual route in a predetermined shape is set in the real space portion including the space in which the floating image is displayed, of the real space spread in front of the user or the surroundings of the image display apparatus. The first displaying device is controlled by the controlling device including, for example, a recording circuit and an arithmetic circuit such that at least one of the plurality of icons is displayed as the floating image disposed along the virtual route in the predetermined shape. The “virtual route” herein is a route in a predetermined shape, virtually set in the real space to be through the space in which the floating image exists, viewed from the user located at the observation position. Moreover, for example, if the image formation surface of the floating image is disposed on the virtual route and at least one icon is displayed as the floating image disposed along the virtual route, the following presentation becomes possible; namely, although other icons are not seen in reality or they do not exist, it can be shown to the user as if the other icons were disposed along the virtual route. Specifically, if the icon of the floating image is displaced along the virtual route, it is possible to make it look like there are icons even in the virtual route portion (which is not seen from the user) located on the extended line of the virtual route portion that is seen from the user. Alternatively, if there are the plurality of icons each displayed as the floating image by the first displaying device, or the plurality of icons including icons displayed as a direct-view image by a second displaying device described later, it is possible to make it look like there are icons even in the virtual route portion located on the extended line of the virtual route portion that is seen from the user.

Therefore, according to the present invention, it is possible to display a stereoscopic two-dimensional image, relatively easily, and its rendering effect can be improved.

In one aspect of the image display apparatus of the present invention, the virtual route is circular.

According to this aspect, the virtual route is circular. The expression “circular” herein includes not only a precise circle but also an ellipse. therefore, by providing the display such that at least one icon displayed as the floating image rotates along the circumference, it is possible to make it look, to the user, as if the other icons were also disposed along the virtual route, and in other words, as if there are a plurality of island-shaped icons arranged in a tube and only one or a plurality of the icons are exposed on the front side.

In another aspect of the image display apparatus of the present invention, an external shape of the image display apparatus is at least partially along the virtual route.

According to this aspect, the external shape of the image display apparatus is at least partially along the virtual route. Therefore, when at least one icon displayed as the floating image is disposed along the virtual route, it is possible to make it look, to the user, as if the other icons, which do not exist in reality, were hidden in the image display apparatus.

In another aspect of the image display apparatus of the present invention, the image display apparatus is further provided with a second displaying device for displaying a second image on a second screen as a direct-view image so as to be viewed from an observation position at which the floating image can be observed, and the controlling device also controls the second displaying device in addition to the first displaying device such that another icon different from the icon displayed by the first displaying device is displayed as a direct-view image disposed along the virtual route.

According to this aspect, the second image is displayed as the direct-view image on the second screen by the second displaying device such as a color liquid crystal display apparatus. Moreover, the second screen is disposed to be seen from the observation position of the floating image, such as at a position vertically, horizontally, or obliquely adjacent to or lined with the floating image, viewed from the observation position of the floating image. The “direct-view image” herein is an image which looks like being displayed on the screen from the user, and in other words, it is an image directly viewed by the user, and it is a concept opposed to the floating image. Therefore, the user views the two types of images together or simultaneously, from the observation position included in both the range of the view angle of the direct-view image and the range of the view angle of the floating image). Moreover, the following operation is performed under the control by the controlling device, with each of the second screen and the image formation surface of the floating image being disposed on the virtual route. In other words, at least one of the plurality of icons is displayed as the floating image disposed along the virtual route, and another icon is displayed as the direct-view image disposed along the virtual route. As described above, the icons displayed not only in the floating image but also in the direct-view image can be operated in conjunction with each other, so that it is possible to make it look, to the user, as if the other icons which are not seen in reality were disposed along the virtual route.

In an aspect in which the second displaying device is further provided, the image display apparatus may be further provided with a position detecting device for outputting a position signal corresponding to a position of a detected object, and the controlling device may control at least one of the first displaying device and the second displaying device to dispose the plurality of icons at positions corresponding to the position of the detected object.

According to this aspect, the position signal corresponding to the position of the detected object is outputted by the position detecting device such as a space sensor, a touch panel, or a turntable. Moreover, at least one of the first displaying device and the second displaying device is controlled by the controlling device on the basis of the outputted position signal to dispose the plurality of icons at the positions corresponding to the position of the detected object. The “position of the detected object” herein includes not only the position of the detected object itself, but also the movement and direction of the position, and the like. specifically, it includes the amount of the user moving the hand on the touch panel, or the amount of rotating the turntable, and the like. For example, the display is performed such that each of the plurality of icons is displaced along the virtual route by a distance equal to or proportional to the amounts. At this time, the icon of the floating image may be displaced on the virtual route in the floating image form, and moreover, the icon of the direct-view image may be displaced along the virtual route in the direct-view image form; however, if there are a plurality of icons (preferably, if there are three or more icons), it is possible to make it look like the icons are displaced on the virtual route, by hanging the floating image and the direct-view image.

Incidentally, if the icon of a certain floating image is displaced and deviates from an area in which the image formation surface can be displayed, the icon may be displayed on an adjacent another image formation surface or second screen. The same is true for a case where it deviates from the second screen. In this manner, it is possible to express the situation that the plurality of icons are continuously displaced along the virtual route.

In an aspect in which the position detecting device is further provided, the position detecting device may output the position signal if the position of the detected object is displaced along the virtual route.

According to this aspect, if the position of the detected object is displaced along the circular virtual route, the position signal is outputted by the position detecting device such as a turntable. As a result, the first displaying device and the second displaying device are controlled to dispose the icon of the floating image and the icon of the direct-view image in a direction along the virtual route. In this manner, a more intuitive operation is possible.

Alternatively, in an aspect in which the second displaying device is further provided, at least three icons of the plurality of icons may be each displayed as the floating image.

According to this aspect, it is possible to express the virtual route spread two-dimensionally or three-dimensionally, while reducing the number of displayed icons as much as possible. However, this does not conceptually exclude the display of only one or two icons. Incidentally, as the number of icons displayed is increased, it is more possible to make it look as if as if the icons were displaced along the virtual route by the change in display, or as if the other icons existed on the portion in which the virtual route is not seen.

According to an aspect in which the plurality of icons are displayed as the floating images or the direct-view images, the second screen or the image formation surface in which the plurality of icons are displayed may have mutually different positions in a depth direction with respect to a user of the display image apparatus.

According to this aspect, the plurality of icons are displayed at the mutually shifted positions in the depth direction with respect to the user of the image display apparatus. Therefore, perspective is further emphasized.

In another aspect of the image display apparatus of the present invention, the position detecting device is provided with one or a plurality of operation buttons, and when any of the one or the plurality of operation buttons is pressed by the detected object, the position detecting device outputs a signal corresponding to the pressed operation button as the position signal.

According to this aspect, the position detecting device is provided with one or a plurality of operation buttons. Then, if any of the operation buttons is pressed by the detected object, the signal corresponding to the pressed operation button is outputted as the position signal. For example, when the floating image of a certain icon is displayed, if the operation button of a turntable type is pressed in a direction crossing the disc surface, it is considered that the icon is selected. In this manner, interactivity is further improved.

In another aspect of the image display apparatus of the present invention, the plurality of icons are displayed in a loop along the virtual route.

According to this aspect, for example, if the user repeats the rotation operation, the plurality of icons are displayed in the loop along the virtual route. Therefore, the icon that is off from one edge of the image formation surface and that is not displayed is displayed again from the other edge, the virtual route can be more easily recognized. This aspect is useful particularly if the virtual route is circular.

In another aspect of the image display apparatus of the present invention, there are a plurality of virtual routes, and each of the virtual routes is disposed in a concentric shape or in a multilayer shape.

According to this aspect, the virtual route includes not only one but also a plurality of virtual routes. Each of the virtual routes is disposed in the concentric shape or in the multilayer shape. Therefore, it is possible to express the more complicated hierarchy structure of the icons. In this case, the plurality of icons are preferably disposed along respective virtual routes, and moreover, three or more icons are preferably disposed along each virtual route. Moreover, the icon may be intentionally disposed on the intersection point of the plurality of virtual routes, and the relevant icon may be able to be selectively disposed along any virtual route.

In another aspect of the image display apparatus of the present invention, the image display apparatus is further provided with a communicating device for communicating with another apparatus, and the communicating device communicates with the another apparatus such that the another apparatus operates on the outputted position signal.

According to this aspect, the image display apparatus can be used as a controller for another apparatus, such as a remote controller. For example, in displaying the list as described above, it is possible to control or operate, for example, an audio system or a video system or the like, which is the another apparatus.

As explained above, according to the image display apparatus of the present invention, it is provided with the first displaying device, the image transmitting device, and the controlling device. Thus, it is possible to display a stereoscopic two-dimensional image, relatively easily, and it is also possible to improve the rendering effect.

### BRIEF DESCRIPTION OF DRAWINGS

FIG. 1 is a perspective view showing the basic structure of an image display apparatus which can display a floating image in an embodiment.

FIG. 2 is a view showing the image display apparatus in the embodiment, viewed from A-A in FIG. 1.

FIG. 3 is a cross sectional view schematically showing the structure of an image transmission panel.

FIG. 4 is a cross sectional view schematically showing the structure of the image transmission panel and the direction of the image (two pieces).

FIG. 5 are cross sectional views schematically showing the structure of the image transmission panel and the direction of the image (a: one piece, b: three pieces).

FIG. 6 is a perspective view showing the basic structure of the image display apparatus in the embodiment.

FIG. 7 is a cross sectional view showing the basic structure of the image display apparatus in the embodiment (3DF method).

FIG. 8 is a cross sectional view showing the basic structure of the image display apparatus in the embodiment (IP method).

FIG. 9 is a cross sectional view showing the basic structure of the image display apparatus in the embodiment (if the position detecting device is a touch panel).

FIG. 10 is a schematic diagram showing the basic structure of the image display apparatus linked to a mobile phone.

FIG. 11 is a flowchart showing the operations of the image display apparatus linked to the mobile phone.

FIG. 12 is a side view showing the image display apparatus which is not provided with a prism sheet.

FIG. 13 are side views showing the image display apparatus which is provided with a prism sheet (a: a prism sheet in a direct-view display device, b: a display device inclined and a prism sheet in the direct-view display device, c: a prism sheet in the display device and the direct-view display device).

FIG. 14 is a cross sectional view showing a cross section in which the prism sheet is partially enlarged.

FIG. 15 is a perspective view showing an intersection line between an image formation surface and a display surface of the direct-view display device.

FIG. 16 are schematic diagrams showing an image formation surface line, which is the intersection line between the image formation surface and the display surface of the direct-view display device (a: side view, b: top view).

FIG. 17 are schematic diagrams showing that a floating image and a direct-view image change in conjunction with each other (a: a direct-view image 352 of a spot is in a floating image display range and behind an intersection line 2135, b: the direct-view image 352 of the spot is on the intersection line 2135, c: the direct-view image 352 of the spot is in the floating image display range and in front of an intersection line 2135).

FIG. 18 is a flowchart showing a process in which the floating image and the direct-view image change in conjunction with each other.

FIG. 19 are schematic diagrams showing that the floating image and the direct-view image change in conjunction with each other (a: first state, b. second state, c: third state, d: fourth state).

FIG. 20 is a flowchart showing a process in which the floating image and the direct-view image change in conjunction with each other.

FIG. 21 are schematic diagrams showing that the floating image and the direct-view image change in conjunction with each other (a: first state, b. second state, c: third state).

FIG. 22 is a flowchart showing a process in which the floating image and the direct-view image change in conjunction with each other.

FIG. 23 are schematic diagrams showing that the floating image and the direct-view image change in conjunction with each other (a: first state, b. second state, c: third state).

FIG. 24 is a flowchart showing a process in which the floating image and the direct-view image change in conjunction with each other.

FIG. 25 are schematic diagrams showing the overall structure of the image display apparatus in a circular shape which can be displayed by combining the floating image and the direct-view image (a: perspective view, b: top view).

FIG. 26 are top views showing a plurality of icons circularly arranged (a: virtual arrangement drawing, b: actual arrangement drawing).

FIG. 27 are schematic diagrams showing the rotational transfer of the plurality of icons circularly arranged (a: first state, b. second state, c: third state, d: fourth state).

FIG. 28 is a flowchart showing a process associated to the rotational transfer of the plurality of icons circularly arranged.

FIG. 29 are schematic diagrams showing the basic structure of a turntable.

FIG. 30 are schematic diagrams showing the icons represented by the floating image and the direct-view image (a: one floating image and two direct-view images, b: three floating images).

FIG. 31 are schematic diagrams showing a virtual hierarchic structure of the icons (a: arranged concentrically, b: arranged in a multilayer disc shape).

### DESCRIPTION OF REFERENCE CODES

100 image display apparatus

11 display device

111 image display surface

13 floating image

15 space

17 image transmission panel

21 image formation surface

23 micro convex lens

231, 232 micro convex lens

24 transparent substrate

25 microlens array

251, 252 lens array half

101 case

102 opening

31, 32, 35 direct-view display device

210 floating image

310, 320, 350 direct-view image

4 position detection device

5 control device

172 integral photography IP microlens array

212 floating image

41 touch panel

211, 212, 213 floating image

61 interface device

200 mobile phone

201 call control device

202 interface device

7 prism sheet

71 inclined surface

2135 intersection line

214 floating image

351, 352 direct-view image

215, 216 floating image

353, 354, 355 direct-view image

217, 218 floating image

356, 357 direct-view image

42 position detection device

219 floating image

358 direct-view image

99 first virtual path

999 second virtual path

9999 third virtual path

### BEST MODE FOR CARRYING OUT THE INVENTION

Hereinafter, the best mode for carrying out the invention will be explained in each embodiment in order, with reference to the drawings.

### (1) FIRST EMBODIMENT

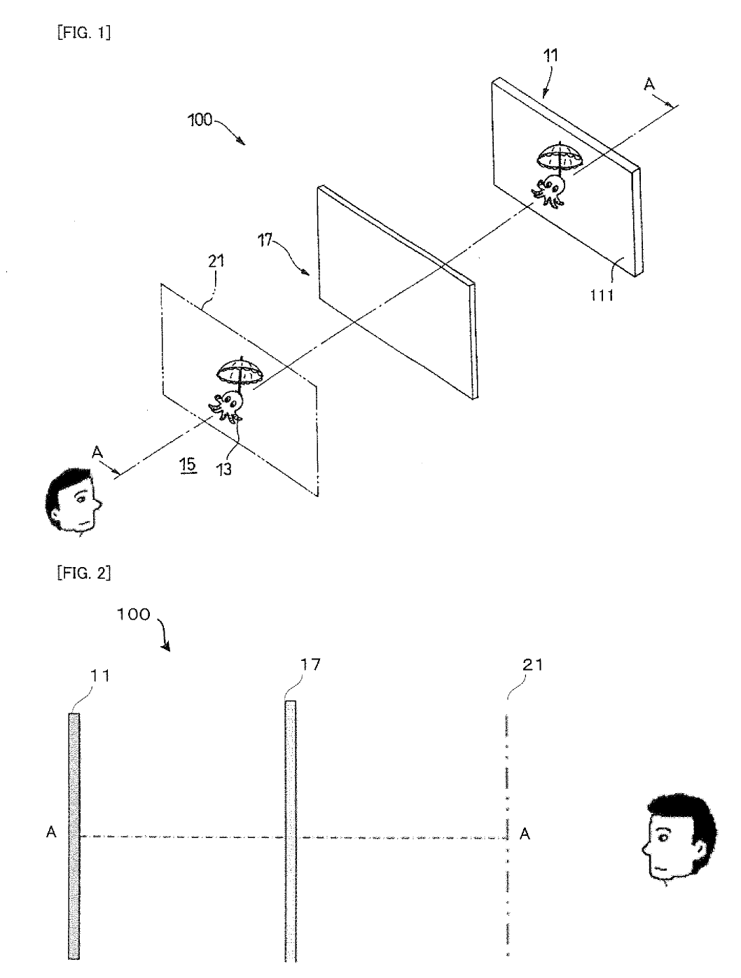

The structure and operation process of an image display apparatus in a first embodiment will be explained with reference to FIG. 1 to FIG. 11.

(1-1) Basic Structure of Image Display Apparatus which can Display Floating Image

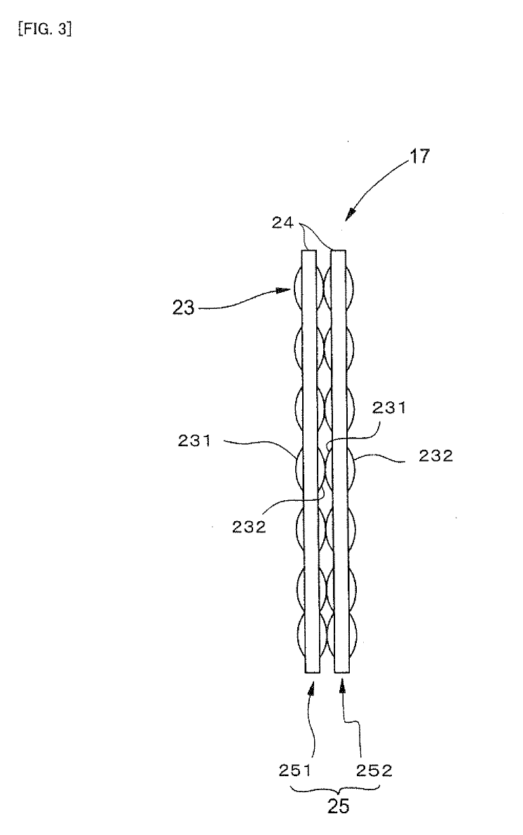

Firstly, the basic structure of the image display apparatus in the embodiment will be explained with reference to FIG. 1 and FIG. 2. FIG. 1 is a perspective view showing the basic structure of the image display apparatus which can display a floating image in an embodiment. FIG. 2 is a view showing the image display apparatus in the embodiment, viewed from A-A in FIG. 1.

As shown in FIG. 1, an image display apparatus 100 in the embodiment is provided with a display device 11 having an image display surface 111; and an image transmission panel 17, and it displays a floating image 13 on an image formation surface 21 in a space 15 on the opposite side to the display device 11. Incidentally, in the embodiment, the display device 11 corresponds to one example of the “first displaying device” of the present invention, and the image transmission panel 17 corresponds to one example of the “image transmitting device” of the present invention.

The display device 11 is, for example, a color liquid crystal display apparatus (LCD). The display device 11 is provided with a color liquid crystal drive circuit (not illustrated), a backlight illumination device (not illustrated), and the like, and it displays a two-dimensional image on the image display surface 111. The color liquid crystal drive circuit outputs a display drive signal on the basis of a video signal inputted from the exterior. The backlight illumination device illuminates the image display surface 111 from the rear if the display device 11 is not of a spontaneous luminescence type. The image display surface 111 displays the two-dimensional image, for example, by changing the direction of liquid crystal molecules and increasing or decreasing light transmittance, on the basis of the outputted display drive signal. Incidentally, the displayed two-dimensional image is eventually displayed as the floating image, so that it is preferably drawn stereoscopically to have depth effect. As the display device 11, various display apparatuses, such as a cathode-ray tube, a plasma display, or an organic electroluminescence display, may be used instead of the color liquid crystal display apparatus (LCD).

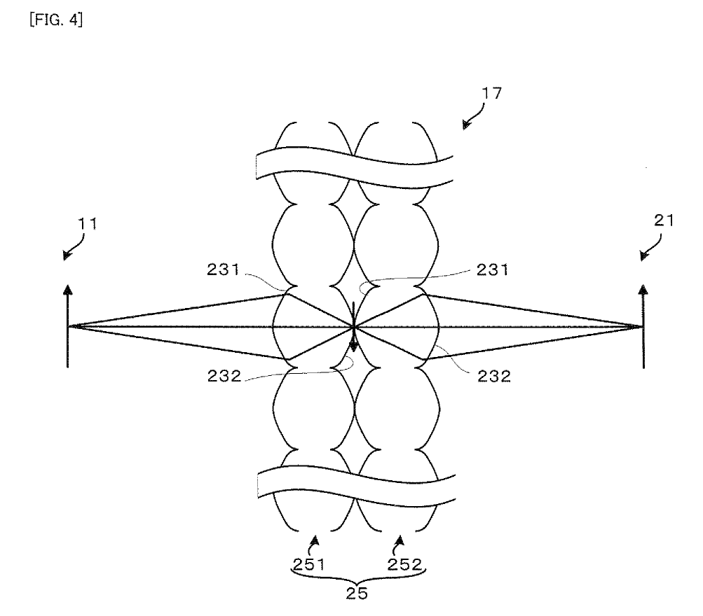

The image transmission panel 17 is formed of, for example, a microlens array (which will be detailed later with reference to FIG. 3), as shown in FIG. 2, and it is alienated from the display device 11. Moreover, the image transmission panel 17 allows the light emitted from the image display surface 111 of the display device 11 (i.e. the display light which constitutes the two-dimensional image) to form an image on the image formation surface 21 in the space 15, to thereby display the floating image 13. Here, the image formation surface 21 is a plane virtually set on the space in accordance with the operation distance of the microlens array, and it is not a real object. Back in FIG. 1, the floating image 13 formed on the image formation surface 21 is displayed with it floating in the space, and thus, for a viewer, it looks like a stereoscopic image is displayed. In other words, the floating image 13 is recognized for the viewer as a pseudo stereoscopic image. In order to strengthen this tendency, the two-dimensional image displayed on the display device 11 may be provided with depth in advance, or the contrast of the two-dimensional image may be emphasized by blacking the background image on the image display surface 111.

As described above, since the image display apparatus 100 is constructed as shown in FIG. 1 and FIG. 2, it is possible to display the floating image 13 on the image formation surface 21 as if the stereoscopic image were displayed.

Next, with reference to FIG. 3 to FIG. 5, the detailed structure of the image transmission panel 17 will be explained. FIG. 3 is a cross sectional view schematically showing the structure of the image transmission panel. FIG. 4 is a cross sectional view schematically showing the structure of the image transmission panel and the direction of the image (two pieces). FIG. 5 are cross sectional views schematically showing the structure of the image transmission panel and the direction of the image (a: one piece, b: three pieces).

As shown in FIG. 3, the image transmission panel 17 is formed of a microlens array 25.

The microlens array 25 is formed, for example, by unifying two pieces of lens array halves 251 and 252.

Each of the lens array halves 251 and 252 has a plurality of micro convex lenses 23 arranged in a two-dimensional matrix on the both sides of a transparent substrate 24, which is made of glass or resins excellent in light transmittance. Each micro convex lens is disposed such that each of the optical axes of micro convex lenses 231 arranged on one side of the transparent substrate 24 matches respective one of the optical axes of micro convex lenses 232 located at opposed positions on the other side. In addition, the lens array halves are overlapped so as to match the optical axes of the adjacent micro convex lenses 232 and 231 between the lens array halves 251 and 252.

Moreover, the image transmission panel 17 is placed a predetermined clearance (operating distance of the microlens array 25) away from and opposed to the image display surface 111 of the display device 11.

Therefore, the image transmission panel 17 transmits the display light of the two-dimensional image, emitted from the image display surface 111 of the display device 11, to the space 15 on the opposite side to the display device 11 and forms an image on the image formation surface 21 which is a predetermined distance away from the image transmission panel 17. As a result, the image transmission panel 17 can display the two-dimensional image displayed by the display device 11, as the floating image 13.

Here, as shown in FIG. 4, the two-dimensional image displayed by the display device 11 is vertically reversed once on the lens array half 251, and again reversed once on the lens array half 252 before it is emitted. By this, the image transmission panel 17 can display the erected image of the two-dimensional image, as the floating image 13.

Incidentally, if the erected image can be obtained as the floating image 13, the structure of the microlens array 25 is not limited to what the two pieces of lens array halves 251 and 252 are unified as a pair. For example, it may be formed of one piece as shown in FIG. 5(a), or it may be formed of two or more pieces as shown in FIG. 5(b).

As described above, if the image transmission panel 17 is constructed as shown in FIG. 3 to FIG. 5, the image display apparatus 100 can preferably display the floating image 13, for example, as the erected image.

(1-2) Regarding Image Display Apparatus which can Display Floating Image and Direct-View Image

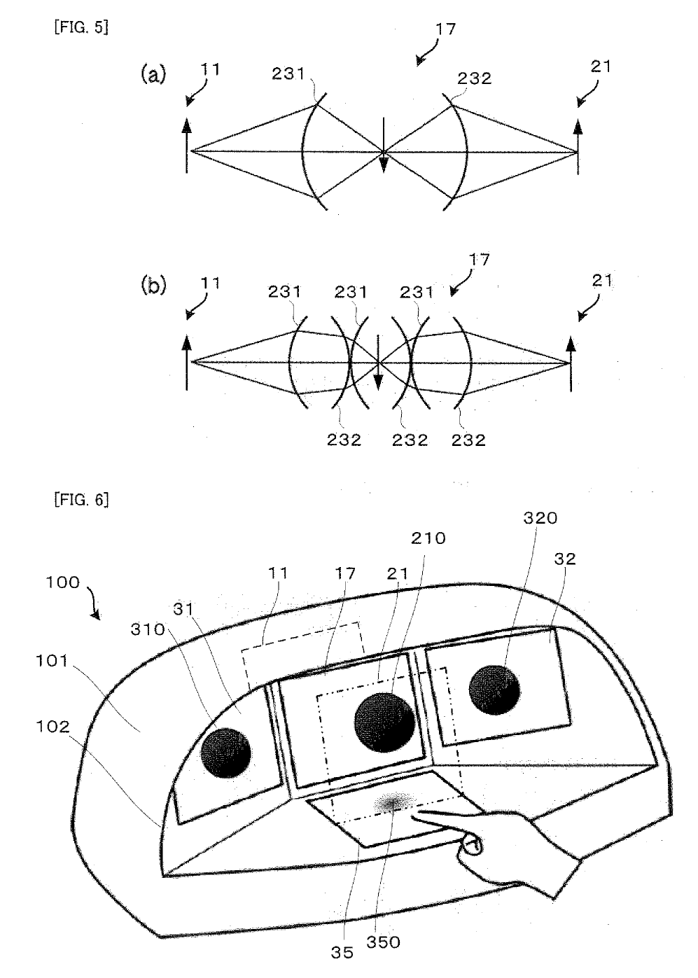

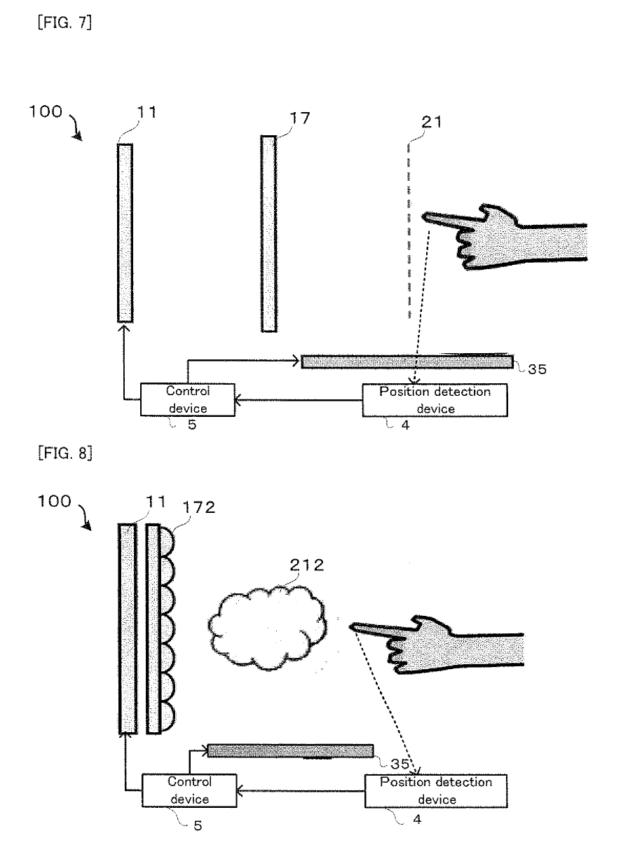

With reference to FIG. 6 to FIG. 11, an explanation will be given on the image display apparatus which can also display the direct-view image in addition to the floating image displayed in the above manner. FIG. 6 is a perspective view showing the basic structure of the image display apparatus in the embodiment.

As shown in FIG. 6, the image display apparatus 100 in the embodiment is provided with a case 101, which has the display device 11, the image transmission panel 17, direct-view display devices 32, 32, 35, and an opening 102, and it can also display the direct-view image in addition to the floating image. Incidentally, in the embodiment, the display device 11 constitutes one example of the “first displaying device” of the present invention. The image transmission panel 17 constitutes one example of the “image transmitting device” of the present invention. Each of the direct-view display devices 32, 32, 35 constitutes one example of the “second displaying device” of the present invention.

The display device 11 and the image transmission panel 17 display a floating image 210 on the image formation surface 21, as explained with reference to FIG. 1 to FIG. 5.

The direct-view display devices 32 and 32 disposed on either side of the image transmission panel 17 are, for example, the same color liquid crystal display apparatuses as the display device 11, and they display direct-view images 310 and 320, respectively.

The direct-view display device 35 disposed on the lower side of the image transmission panel 17 is also, for example, the same color liquid crystal display apparatuses as the display device 11, and it displays a direct-view image 350. Setting the direct-view image 350 to the shadow of the floating image 210 or a reflected image of the floating image 210 provides a by far better spatial effect of the floating image 210.

The case 101 holds various members such as the aforementioned display device 11 and has the opening 102 on the front on a user's side. Hence, the user whose right hand is shown in FIG. 6 can view the floating image 210 and the direct-view images 310, 320, and 350 from the front side. Each of the display device 11, the image transmission panel 17, and the direct-view display devices 31, 32, and 35 is disposed such that the observation position of the user whose right hand is shown in FIG. 6 is in a range of the view angle of the floating image 210 and in a range of the view angle of each of the direct-view images 310, 320, and 350. In other words, the user views the plurality of images from the observation position (typically, the position facing the floating image).

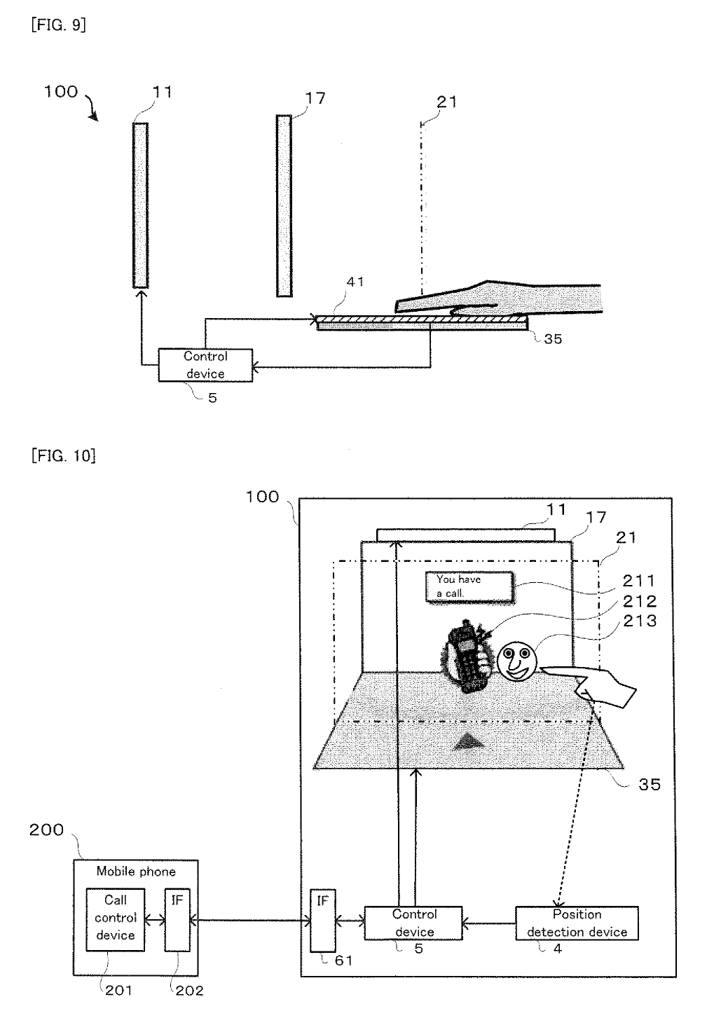

In particular, in the embodiment, the image display apparatus 100 explained with reference to FIG. 6 can change at least any of the floating image and the direct-view images, in accordance with the position and motion of a detected object such as the user's hand. The detailed structure will be explained with reference to FIG. 7 to FIG. 9 in addition to FIG. 6. FIG. 7 is a cross sectional view showing the basic structure of the image display apparatus in the embodiment (3DF method). FIG. 8 is a cross sectional view showing the basic structure of the image display apparatus in the embodiment (IP method). FIG. 9 is a cross sectional view showing the basic structure of the image display apparatus in the embodiment (if the position detecting device is a touch panel).

As shown in FIG. 7, the image display apparatus 100 in the embodiment is provided with the display device 11, the image transmission panel 17, the direct-view display device 35, a position detection device 4, and a control device 5. Incidentally, the direct-view display devices 31 and 32 are not illustrated for convenience.

The display device 11 and the image transmission panel 17 display the floating image on the image formation surface 21. The floating image is not necessarily displayed in the 3D floating vision method, explained with reference to FIG. 1 to FIG. 5. Since the real image is preferred as the floating image, it may be displayed, for example, in an IP (integral photography) method which also provides the real image as in the 3D floating vision method.

As shown in FIG. 8, in the IP method, an image transmission panel 172 is, for example, a pinhole array, a microlens array, or a lenticular lens, and it is disposed closer to the display device 11 than in the 3D floating vision method. The image transmission panel 172 is used to change or control not the formed image in the 3D floating vision method but the direction of the light beam, and therefore, the user feels that a floating image 212 displayed through the image transmission panel 172 has a depth rather than a plane. However, the image displayed on the display device 11 in the IP method needs to be not a simple two-dimensional image as in the 3D floating vision method but a complicated two-dimensional image peculiar to the IP method considered to have the depth. As described above, in terms of image production cost, the 3D floating vision method may be more preferable than the IP method.

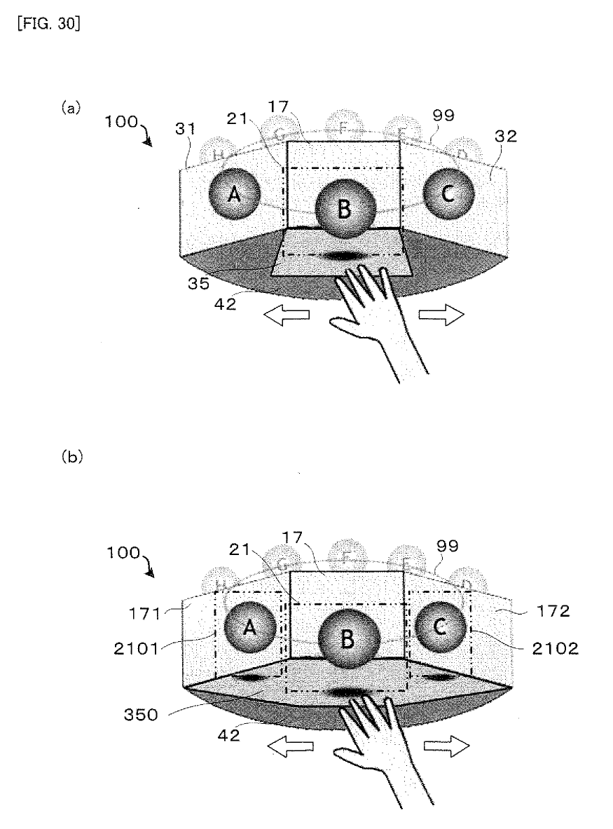

Back in FIG. 7 again, the position detection device 4 specifies the position or motion of the detected object such as the user's finger if the detected object enters in a predetermined area. In addition, the position detection device 4 is electrically connected to the control device 5 and transmits the detection result to the control device 5. The position detection device 4 is, for example, a space sensor using an imaging element (or image pickup device) or ultrasound, and it detects the ultrasound reflected by the detected object with a piezoelectric element, to thereby detect the position of the detected object. The position detection device 4 may be also a touch panel 41 disposed on the direct-view display device 35 as shown in FIG. 9. The touch panel 41 is, for example, a panel in which the piezoelectric elements are arranged in a matrix, and it transmits information about which position is touched on the panel, to the control device 5 as the detection result when the user's finger or the like touches the panel. In the touch panel, the method is no object; it may be a resistive method, a capacitance method, an infrared ray method, or the like. Alternatively, the position detection device 4 may be an operation controller, such as a turntable described later using FIG. 29. Moreover, it may be an arbitrary combination of the space sensor, the touch panel, the turn table and the like.

Back in FIG. 7, the control device 5 is provided with, for example, a known central processing unit (CPU), a read-only memory (ROM) for storing a control program therein, a random access memory (RAM) for storing various data therein, and an arithmetic-logic circuit, centered on a memory apparatus, for storing and generating data for display image or the like. The control device 5 controls the display device 11 and the direct-view display devices 31, 32, and 35 to change the floating image or the direct-view images on the basis of the detection result of the position detection device 4.

As described above, since the image display apparatus 100 in the embodiment is constructed as explained with reference to FIG. 6 to FIG. 9, it can change at least one of the floating image or the direct-view images in accordance with the position and motion of the detected object such as the user's hand. As a result, it is possible to improve the interactivity or operability of the image display apparatus 100. In particular, in the embodiment, as shown in FIG. 6, the plurality of images are displayed to surround the user, with the floating image located in the center. Thus, the interactivity or operability can be improved in the image space which is excellent in realistic sensation and which is spread in front of the user.

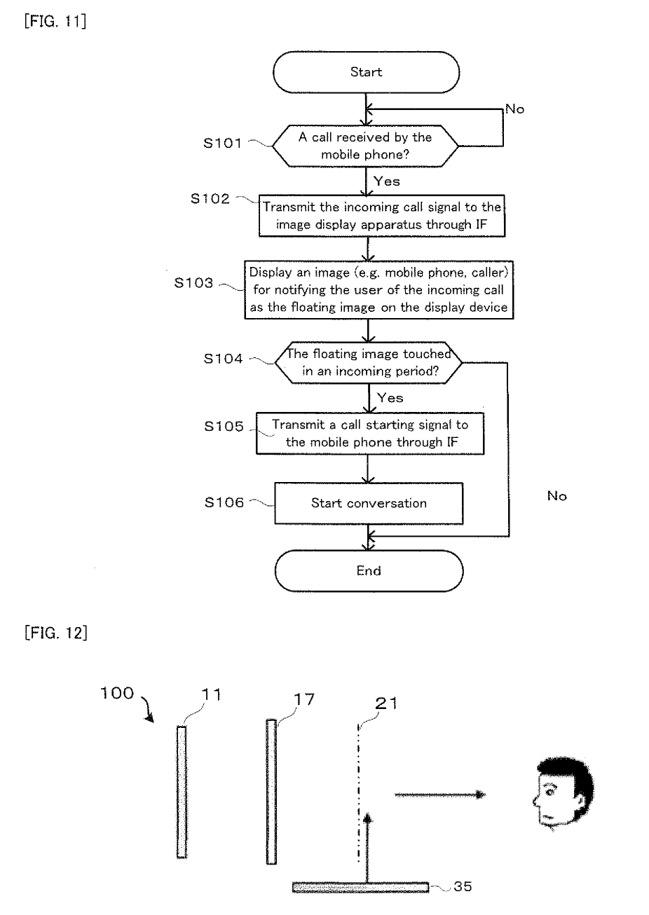

With reference to FIG. 10 and FIG. 11, an explanation will be given on the operation example of the image display apparatus 100 linked to a mobile phone by taking advantage of this. FIG. 10 is a schematic diagram showing the basic structure of the image display apparatus linked to a mobile phone.

In FIG. 10, a mobile phone 200 and the image display apparatus 100 can communicate with each other through their own interface devices 202 and 61.

The interface device 202 of the mobile phone 200, when receiving a call, transmits a signal indicating the incoming call, in which the transmission is instructed from a call control device 201 electrically connected, to the image display apparatus 100 side. On the other hand, it receives a signal from the image display apparatus 100 and transmits it to the call control device 201. In accordance with the signal received from the image display apparatus 100 as described above, the call control device 201 starts a call process.

The interface device 61 of the image display apparatus 100 receives the signal which indicates the incoming call from the mobile phone 200 and transmits it to the control device 5 electrically connected. The control device 5 controls the display device 11 to display floating images 211, 212, and 213 which indicate the incoming call, on the basis of the received signal. On the other hand, if it receives an instruction from the control device 5 to transmit a signal which indicates starting a call, the interface device 61 transmits the signal to the mobile phone 200 side.

Incidentally, the communication between the interface devices 202 and 61 is not only wired communication but may be wireless communication such as infrared communication.

Incidentally, apart from when the call is received, for example, when an email is received, the image display apparatus 100 may display the email on the floating image or direct-view image, or display a predetermined website.

As explained above, the image display apparatus 100 and the mobile phone 200 constructed as shown in FIG. 10 work together and operate as shown in FIG. 11. FIG. 11 is a flowchart showing the operations of the image display apparatus linked to the mobile phone.

In FIG. 11, firstly, it is regularly or irregularly judged whether or not the mobile phone 200 receives a call while the user is driving a vehicle (step S101). If the mobile phone 200 does not receive a call. (the step 5101: NO), a process is not particularly performed. On the other hand, if the mobile phone 200 receives a call (the step 5101: YES), the call control device 201 transmits the incoming call signal which indicates the incoming call, to the control device 5 through the interface devices 202 and 61 (step S102).

The control device 5 receives the incoming call signal and displays a two-dimensional image for notifying the user of the incoming call, on the display device 11 (step S103). At this time, as the two-dimensional image, for example, a two-dimensional image of text of “You have a call”, a two-dimensional image of the mobile phone, or a two-dimensional image of the photograph of a caller's face may be displayed. At this time, the floating image displayed on the image formation surface 21 may be like the floating images 211, 212, and 213 in FIG. 10.

Here, it is judged whether or not the user's hand is detected in an incoming period by the position detection device 4 (step S104). In other words, it is judged whether or not the user expresses the user's will of answering the call in the incoming period by touching the floating image 212 or performing similar actions. The incoming period herein is a period in which the caller is making a phone call or a period set in advance on the user's side.

If the user's hand is not detected in the incoming period (the step 5104: NO), that means the user cannot talk over the phone. Thus, the process is ended without a conversation started.

On the other hand, if the user's hand is detected in the incoming period (the step 5104: YES), the control device 5 transmits a call starting signal to the call control device 201 through the interface devices 61 and 202 (step S105).

The call control device 201 which has received the call starting signal starts the call process (step S106); namely, the user can talk with the caller. Incidentally, the conversation is preferably made hands-free for safety. With this, the image display apparatus 100 may be further provided with an audio input/output device, and the interface devices 202 and 61 may be capable to exchange the conversation audio.

Incidentally, during this time, the direct-view display device 35 displays, for example, car navigation for displaying the position of a vehicle travelling as a map image, or the like, and when the call is received, the direct-view display device 35 notifies the user of the incoming call by popping up the floating image on the map image.

As explained with reference to FIG. 10 and FIG. 11, the image display apparatus 100 is linked to the mobile phone 200, so that it is possible to provide a further interactive user interface using the floating image.

### (2) SECOND EMBODIMENT

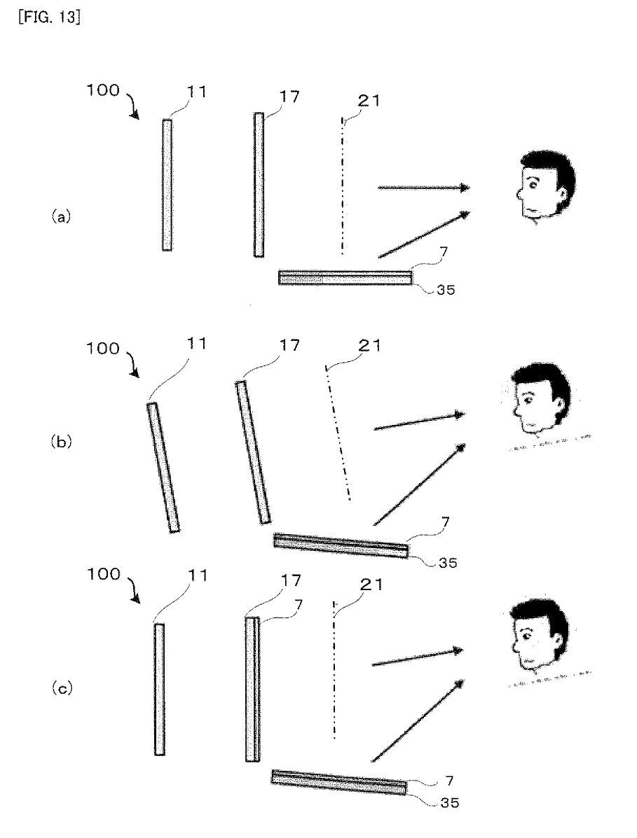

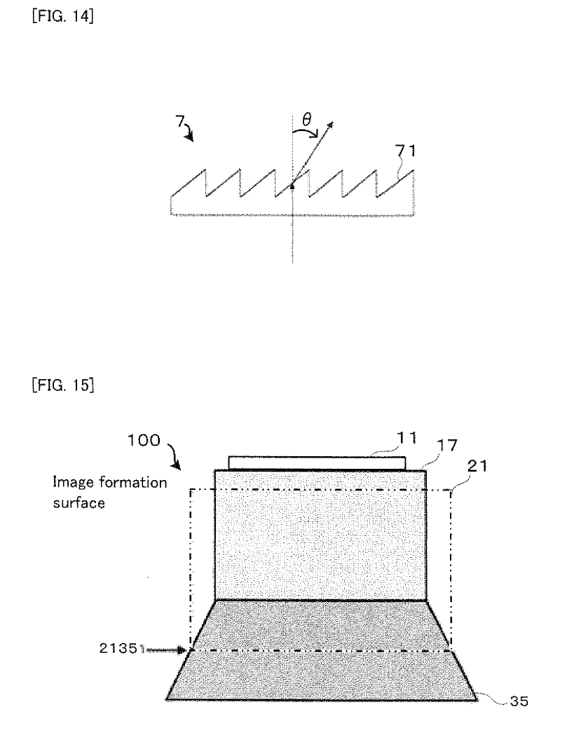

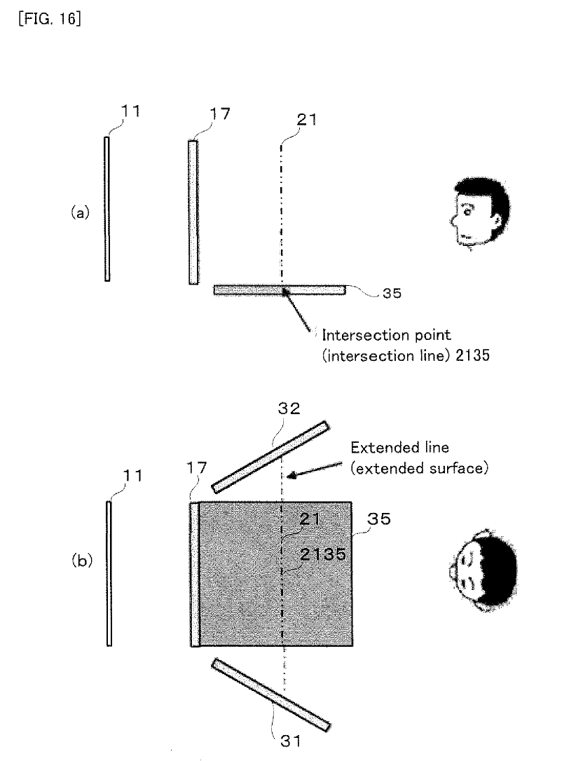

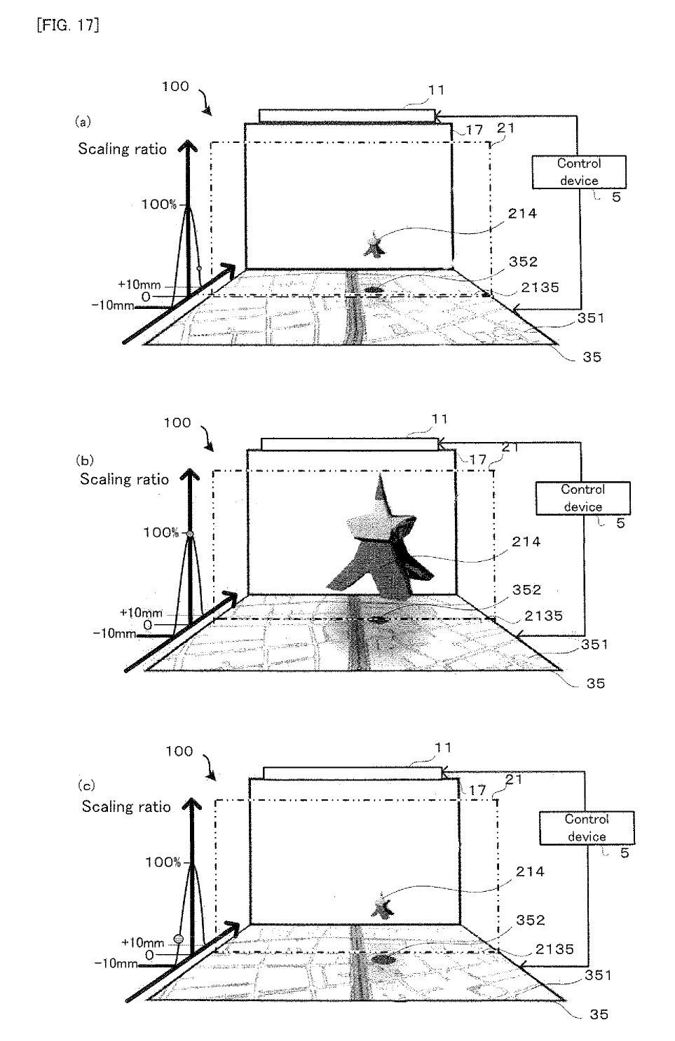

Next, an image display apparatus in a second embodiment will be explained and compared to a comparison example, with reference to FIG. 12 to FIG. 14. FIG. 12 is a side view showing the image display apparatus which is not provided with a prism sheet. FIG. 13 are side views showing the image display apparatus which is provided with a prism sheet (a: a prism sheet in a direct-view display device, b: a display device inclined and a prism sheet in the direct-view display device, c: a prism sheet in the display device and the direct-view display device). FIG. 14 is a cross sectional view showing a cross section in which the prism sheet is partially enlarged. Incidentally, the same constituents as those in the first embodiment carry the same reference numerical, and their detailed explanation will be omitted as occasion demands.

The image display apparatus in the embodiment is particularly provided with a prism sheet, as one example of the “optical member” of the present invention, which can correct the entire range of the view angle to the observation position side where the user is assumed to be located, so that the floating image and the direct-view image can be viewed more easily from the user.

Firstly, the image display apparatus in the comparison example will be explained. As shown in FIG. 12, the floating image displayed on the image formation surface 21 of the image display apparatus 100 in the comparison example is easy to be viewed for the user. This is because the display panel 11 and the image transmission panel 17 are disposed to face the user. On the other hand, compared to the floating image, the direct-view image displayed is hard to be viewed for the user. This is because the display light of the direct-view image is emitted from the direct-view display device 35 such that its center line or optical axis matches a direction substantially perpendicular to the user's view line. In other words, the direct-view image is observed from the user, as an image whose brightness and color are deteriorated to a greater or lesser degree, near the corner of the range of the view angle or at a certain degree of distance from the range of the view angle.

In order to solve such a disadvantage, the image display apparatus 100 in the embodiment is further provided with a prism sheet 7, as shown in FIG. 13(a) to FIG. 13(c).

In FIG. 13(a), the image display apparatus 100 in the embodiment is further provided with the prism sheet 7 on the optical path of the display light emitted from the direct-view display device 35. The prism sheet 7 is constructed as shown in FIG. 14; namely, the prism sheet 7 is provided with a plurality of inclined surfaces 71 formed at a predetermined pitch. The direction of the display light emitted from the direct-view display device 35 is changed by a predetermined angle B in accordance with the inclination angle or refractive index of the inclined surfaces 71. The “predetermined angle” herein may be determined in advance by experiences, experiments, or simulations, as the assumed value of an angle between the user's view line and the direction of the display light emitted from the direct-view display device 35 (i.e. the optical axis direction of the display light, and in other words, the normal direction of the screen of the direct-view display device 35). If the prism sheet 7 is designed in this manner, the display light emitted from the direct-view display device 35 is reflected on the inclined surfaces 71 and transmitted toward the user. As a result, the direct-view image displayed on the direct-view display device 35 of the image display apparatus 100 in the embodiment is easily viewed by the user than in the comparison example. In other words, the direct-view image is observed from the user as an image excellent in brightness and color, near the center of the range of the view angle or at least without being distant from the range of the view angle.

If the user's view line crosses not only the display light emitted from the direct-view display device 35 but also the display light emitted from the image transmission panel 17 (the display device 11), for example, if the user looks down the image display apparatus 100 from the above, the image display apparatus 100 may be constructed as described in FIG. 13(b) or FIG. 13(c) below.

In FIG. 13(b), the image display apparatus 100 not only further has the prism sheet 7 on the optical path of the display light emitted from the direct-view display device 35 but also inclines each of the display device 11, the image transmission panel 17, and the direct-view display device 35 in the user's view line direction. As a result, it is also possible to respond to a case where the user's view line crosses the display light of the floating image, for example, a case where the user looks down the image display apparatus 100 from the above.

In FIG. 13(c), the image display apparatus 100 is further provided with not only the prism sheet 7 on the optical path of the display light emitted from the direct-view display device 35, but also the prism sheet 7 as another example of the “optical member” of the present invention even on the optical path of the display light emitted from the image transmission panel 17 (the display device 11). As a result, it is also possible to respond to the case where the user's view line crosses the display light of the floating image, for example, the case where the user looks down the image display apparatus 100 from the above.

Incidentally, of course, the prism sheet 7 may be provided not only for the direct-view display device 35 or the image transmission panel 17 but also for the other direct-view display devices 31 and 32.

As explained with reference to FIG. 12 to FIG. 14, according to the image display apparatus 100 in the embodiment, it is possible to extend and correct the view angle.

### (3) THIRD EMBODIMENT

Next, an image display apparatus in a third embodiment will be explained. The image display apparatus 100 in the embodiment is particularly adapted to perform the presentation that the floating image and the direct-view image are linked, in the vicinity of an intersection line between the image formation surface 21 and the direct-view display device 35.

Firstly, with reference to FIG. 15 and FIG. 16, the intersection line between the image formation surface 21 and the direct-view display device 35 will be explained, and then the specific embodiment will be explained. FIG. 15 is a perspective view showing the intersection line between the image formation surface and the display surface of the direct-view display device. FIG. 16 are schematic diagrams showing an image formation surface line, which is the intersection line between the image formation surface and the display surface of the direct-view display device (a: side view, b: top view). Incidentally, the same constituents of the first and second embodiments carry the same reference numerals, and their detailed explanation will be omitted as occasion demands.

As shown in FIG. 15, the image display apparatus 100 in the embodiment is provided with the display device 11, the image transmission panel 17, and the direct-view display device 35. As described above with reference to FIG. 1, the display device 11 and the image transmission panel 17 are disposed to face each other. Therefore, the image formation surface 21 is located in the space on the opposite side to the display device 11. The direct-view display device 35 is disposed in a direction crossing the image formation surface 21.

An intersection line 2135 denotes a portion in which the image formation surface 21 crosses the direct-view display device 35. Moreover, as shown in FIG. 16(a), if viewed from the side surface of the image display apparatus 100, the intersection line 2135 looks like the intersection point between the image formation surface 21 and the direct-view display device 35.

On the other hand, as shown in FIG. 16(b), if viewed from the top surface of the image display apparatus 100, it looks like the intersection line 2135 matches the image formation surface 21 of the direct-view display device 35. Incidentally, the intersection line 2135 may include the portion in which the image formation surface 21 crosses the direct-view display device 35, as well as its extended line; namely, it conceptually includes the intersection line of the extended surface of the image formation surface 21 and the extended surface of the direct-view display device 35. Moreover, there are also the intersection lines of the extended surface of the image formation surface 21 and the direct-view display devices 31 and 32, and in the vicinity of the intersection lines, the presentation that the floating image and the direct-view images are linked may be performed.

As described above, the floating image and the direct-view image can be displayed in closer conjunction with each other, by changing the floating image displayed on the image formation surface 21, in accordance with the relative positional relation of the direct-view image displayed on the direct-view display device 35, on the basis of the intersection line 2135 explained with reference to FIG. 15 and FIG. 16. This specific aspect will be explained with reference to FIG. 17 to FIG. 24.

### (3-1) First Aspect

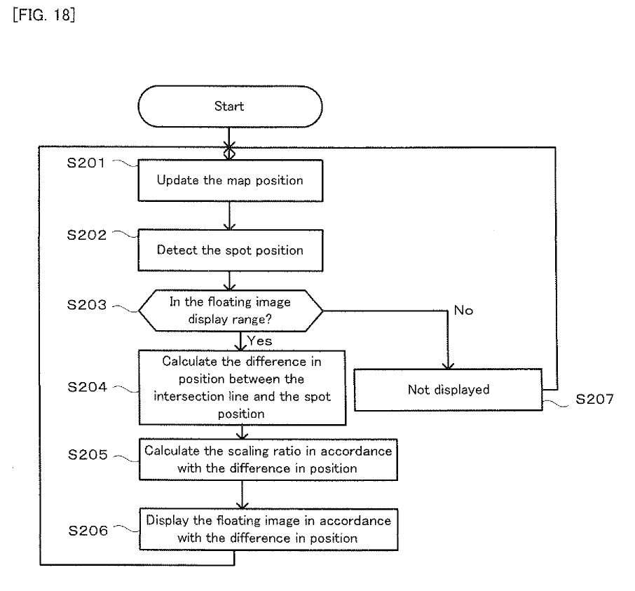

Firstly, a first aspect of the image display apparatus in the embodiment will be explained with reference to FIG. 17(a) to FIG. 17(c), and FIG. 18. FIG. 17 are schematic diagrams showing that the floating image and the direct-view image change in conjunction with each other (a: a direct-view image 352 of a spot is in a floating image display range and behind the intersection line 2135, b: the direct-view image 352 of the spot is on the intersection line 2135, c: the direct-view image 352 of the spot is in the floating image display range and in front of an intersection line 2135). FIG. 18 is a flowchart showing a process in which the floating image and the direct-view image change in conjunction with each other.

The image display apparatus 100 in the aspect is characterized in that it uses video representation in which the floating image appears and gradually increases in size if a predetermined spot in the direct-view image is scrolled or slid automatically or by the user's operation and the spot is brought close to the intersection line between the image formation surface and the display surface of the direct-view display device, and in which the floating image gradually decreases in size and disappears if the predetermined spot is brought away from the intersection line.

As shown in FIG. 17(a) to FIG. 17(c), in this aspect, it is assumed that the image display apparatus 100 is a car navigation which displays the position of a vehicle travelling as a map image. The display device 11 and the image transmission panel 17 are disposed to face each other, as described above with reference to FIG. 1. Therefore, the image formation surface 21 is located in the space on the opposite side to the display device 11. The direct-view display device 35 is disposed in the direction crossing the image formation surface 21.

It is assumed that a direct-view image 351 displayed on the direct-view display device 35 is, for example, a surrounding map of the area in which the vehicle provided with the image display apparatus 100 is travelling.

It is assumed that a floating image 214 formed on the image formation surface 21 is information (e.g. space structure, or text information, or the like) about an object displayed on the direct-view image 351 (e.g. a notable site such as the Tokyo tower, a building, or a crossing).

The direct-view image 352 is a spot which indicates the position in the map, i.e. a mark or an image which shows a shadow, of the object displayed as the floating image 214. The direct-view image 352 of the spot typically corresponds to the floating image 214 which indicates the information about the direct-view image 352, in a one-to-one manner.

The control device 5 controls each of the display device 11 and the direct-view display device 35 to change the floating image 214 and the direct-view images 35 and 352.

The operation of the image display apparatus 100 constructed in the above manner will be explained in line with FIG. 18, with reference to FIG. 17(a) to FIG. 17(c) as occasion demands.

In FIG. 18, firstly, the direct-view image 351 of the surrounding map is updated, regularly or irregularly, with the travel of the vehicle (step S201). The updated information at this time is determined by reading, if necessary, road map information recorded a CD or DVD as in the normal car navigation and by verifying it with information about a self-car travel route, which is specified by combining GPS (Global Positioning System) and autonomous navigation.

Then, the relative position of the direct-view image 352 of the spot with respect to the intersection line 2135, in the direct-view image 351 of the surrounding map, is detected by the control device 5 (step S202). Then, it is judged whether or not the detected position is in a floating image display range (step S203). Specifically, if the relative arrangement of the display device 11, the image transmission panel 17, and the direct-view display device 35 is determined in advance, the position of the intersection line 2135 is also determined in advance. Therefore, how far the direct-view image 352 of the spot is from the intersection line 2135 in the direct-view image 351 of the surrounding map can be specified by the control device 5 for managing the display content of the direct-view image 352 of the spot, and the direct-view image 351 of the surrounding map.

Here, if it is beyond the floating image display range (the step S203: NO), the floating image 214 corresponding to the direct-view image 352 of the spot is not displayed (step S207).

On the other hand, if it is in the floating image display range (the step S203: YES), for example, as shown in FIG. 17(a), the floating image 214 corresponding to the direct-view image 352 of the spot is displayed. For example, if the direct-view image 352 of the spot shows the position of the

Tokyo tower, the floating image 214 is displayed as a stereoscopic image of the Tokyo tower. At this time, the following process is performed to change the size of the floating image 214 displayed at this time, in accordance with the difference in position between the intersection line 2135 and the direct-view image 352 of the spot.

Firstly, the difference in position between the intersection line 2135 and the direct-view image 352 of the spot is calculated (step S204). The difference in position may denote the difference in position in a direction perpendicular to the intersection line 2135 or in a direction along the intersection line 2135, or it may denote the distance between a predetermined point on the intersection line 2135 and the direct-view image 352 of the spot.

Then, a scaling ratio is calculated in accordance with the calculated difference in position (step S205). For example, the scaling ratio is calculated such that the larger floating image 214 is displayed as the calculated difference in position is smaller.

Then, the floating image 214 is displayed to have a size corresponding to the calculated scaling ratio (step S206). For example, in FIG. 17(b), the direct-view image 352 of the spot crosses the intersection line 2135 and it is closer to the intersection line 2135 than in FIG. 17(a). Therefore, the scaling ratio of the floating image 214 in FIG. 17(b) is set to be greater than in FIG. 17(a).

Then, the aforementioned process is repeated regularly or irregularly. Then, if the vehicle proceeds and if the direct-view image 352 of the spot is located in the floating image display range and in front of the intersection line 2135, as shown in FIG. 17(c), the floating image 214 is displayed to be smaller again than in FIG. 17(b). Then, if the vehicle further proceeds and if the direct-view image 352 of the spot is beyond the floating image display range, the floating image 214 is not displayed. At this time, if another spot is newly located in the floating image display range, a floating image corresponding to this another spot may be displayed separately.

As described above, according to the first aspect explained with reference to FIG. 17(a) to FIG. 17(c), the floating image 214 is dynamically changed in accordance with the relative positional relation of the direct-view image 352 of the spot with respect to the intersection line 2135, in the direct-view image 351 of the surrounding map, which improves the expressiveness of the image display apparatus 100.

Incidentally, the reason to calculate the scaling ratio as described above is as follows; namely, as the condition to display the floating image 214, the direct-view image 352 of the spot does not necessarily completely match the intersection point (intersection line). In other words, if the direct-view image 352 of the spot is located in the floating image display range from the intersection point (intersection line), the floating image 214 corresponding to the direct-view image 352 of the spot may be displayed. The “floating image display range” herein may be set in advance, for example, to be 20% of the depth of the direct-view display device 35 in the direction perpendicular to the intersection line 2135. If the direct-view display device 35 has a depth of 100 mm in the direction perpendicular to the intersection line 2135, the floating image display range is 20% of 100 mm, i.e. 20 mm. More specifically, as shown in FIG. 17(a) to FIG. 17(c), the floating image display range has a width of 10 mm, each in front of and behind the intersection line 2135, in the direction perpendicular to the intersection line 2135. When the direct-view image 352 of the spot is located in such a floating image display range, the association between the floating image 214 and the direct-view image 352 is easily recognized even if the corresponding floating image 214 is displayed, so that a sense of discomfort is reduced.

Moreover, for example, even if the spot is displaced in the direction along the intersection line 2135 up to the position of the edge where the floating image cannot be displayed on the image formation surface, the floating image 214 is preferably changed and displayed to be gradually less and then not displayed.

### (3-2) Second Aspect

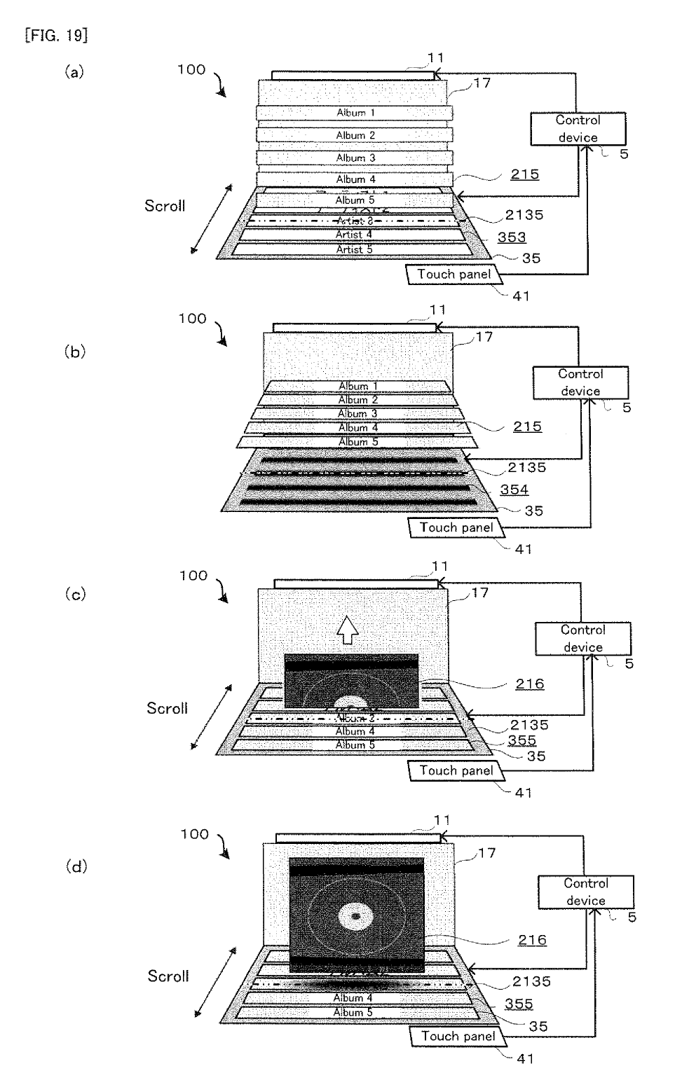

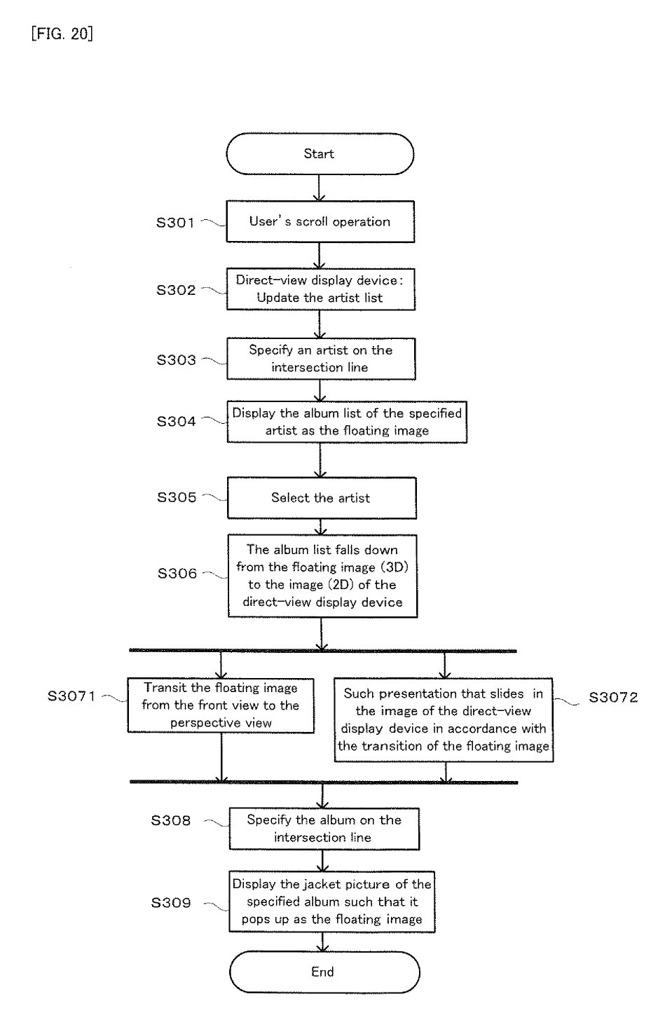

Next, a second aspect of the image display apparatus in the embodiment will be explained in line with FIG. 20, with reference to FIG. 19(a) to FIG. 19(d) as occasion demands. FIG. 19 are schematic diagrams showing that the floating image and the direct-view image change in conjunction with each other (a: first state, b. second state, c: third state, d: fourth state). FIG. 20 is a flowchart showing a process in which the floating image and the direct-view image change in conjunction with each other.

As shown in FIG. 19(a), according to the image display apparatus 100 in the aspect, for example, a direct-view image 353 of an artist list is displayed in the depth direction of the direct-view display device 35. Then, of the list, information about an artist on the intersection line 2135 is displayed as a floating image 215 of an album list.

The image display apparatus 100 in the aspect is characterized in that it is an interactive system for changing the floating image if what is desired to be seen of the list displayed on the direct-view display device 35 is displaced to the vicinity of the intersection lien 2135 by a scroll operation or the like. In addition, in order to make the more effective linkage between the direct-view image and the floating image, the image display apparatus 100 is also characterized in that it uses video representation in which the floating image pops up from the direct-view display device 35, or that it uses video representation in which the floating image enters in the direct-view display device 35.

In FIG. 20, firstly, the scroll operation by the user with a touch panel or the like is detected (step S301). In accordance with the scroll operation, the direct-view image 353 of the artist list displayed on the direct-view display device 35 is updated, and a new artist is displayed (step S302). Simultaneously with the updating, an artist located on the intersection line 2135 of the artists included in the direct-view image 353 of the artist list is specified by the control device 5 (step S303). Then, as shown in FIG. 19(a), as the information about the specified artist, for example, the album of the artist is displayed as the floating image of the album list (step S304).

Here, in order for the user to select the desired artist while browsing the floating image 215, for example, the user may touch a selection button displayed on the direct-view display device 35 when the artist is located on the intersection line 2135 (step S305). From the touch panel 41 attached to the direct-view display device 35, which artist is selected is transmitted to the control device 5. Then, as shown in FIG. 19(b), the place to display the album list of the selected artist is changed from the display device 11 to the direct-view display device 35. In order to naturally represent the change, for example, such a rendering effect is added that the floating image 215 of the album list falls toward the direct-view display device 35 (step S306). Specifically, the control device 5 controls the display device 11 to change the viewpoint step-by-step from the front view to the perspective view of the floating image 215 of the album list (step S3071). In parallel with this, the control device 5 controls the direct-view display device 35 to display such a direct-view image 354 that the album list slides into, i.e. fades in, the direct-view display device 35 (step S3072). By linking the floating image to the direct-view image in this manner, such a presentation is made that the album list of the selected artist falls from the floating image 215 to the direct-view display device 35.

Then, of the direct-view image 355 of the album list which falls down, an album located on the intersection line 2135 is specified by the control device 5 (step S308). Incidentally, the album located on the intersection line 2135 can be changed by the user's scroll operation. Then, the control device 5 controls the display device 11 such that it looks like the specified album jacket pops up as the floating image, as in a floating image 216 of a jacket shown in FIG. 19(c) and FIG. 19(d) (step S309). At this time, in order to emphasize the pop-up state of the floating image 216 of the jacket, the control device 5 may control the direct-view display device 35 to display an image corresponding to the shadow of the jacket near the intersection line 2135. Then, if the user touches the floating image 216 of the jacket, or if the user presses a determination button displayed on the direct-view display device 35 with the floating image 216 of the jacket popping up, music pieces included in this album are played, or the music pieces included in the album are further displayed as the direct-view image or the floating image.

As explained in line with FIG. 20 with reference to FIG. 19(a) to FIG. 19(d) as occasion demands, according to the image display apparatus 100 in the aspect, such an interactive system is realized that the direct-view image and the floating image are changed in conjunction with each other in accordance with the user's operation.

In addition, when the direct-view image and the floating image are linked, the linkage state can be represented, more naturally or more effectively, by setting various effects.

### (3-3) Third Aspect

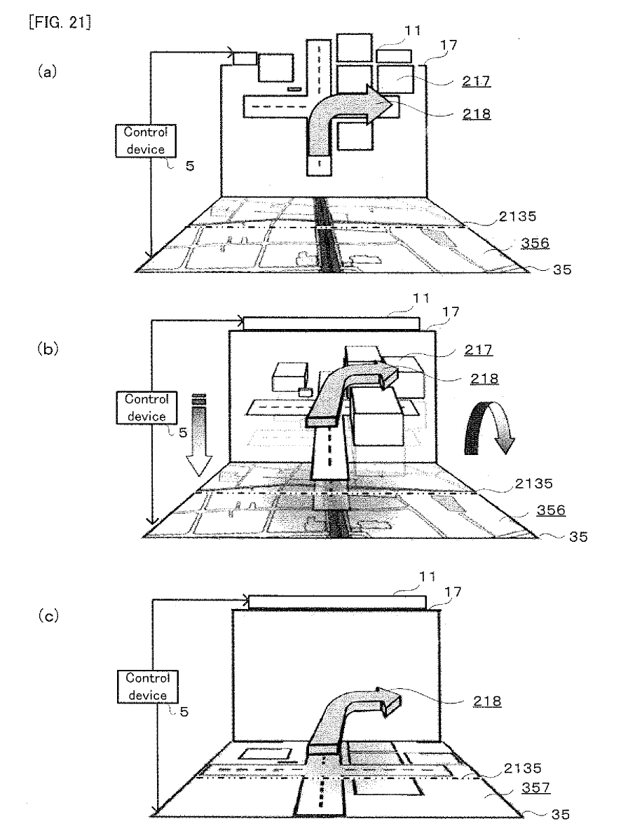

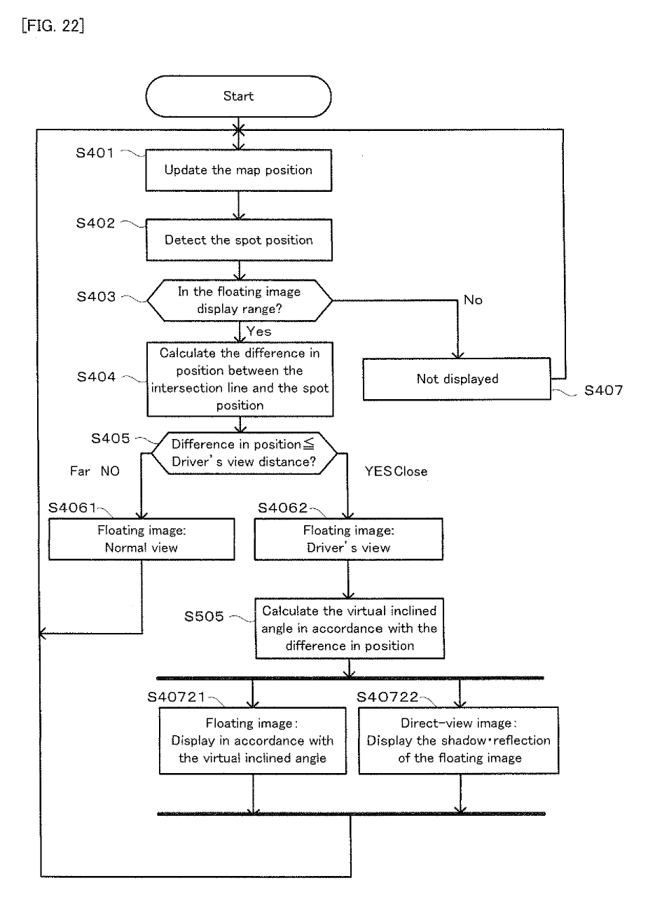

Next, a third aspect of the image display apparatus in the embodiment will be explained in line with FIG. 22, with reference to FIG. 21(a) to FIG. 21(c) as occasion demands. FIG. 21 are schematic diagrams showing that the floating image and the direct-view image change in conjunction with each other (a: first state, b. second state, c: third state).

FIG. 22 is a flowchart showing a process in which the floating image and the direct-view image change in conjunction with each other.

The image display apparatus 100 in the aspect is characterized in that it improves the expressiveness by dynamically changing the floating image or the direct-view image in accordance with the relative positional relation between the predetermined spot in the floating image and the direct-view image, and the intersection line of the image formation surface and the display surface of the direct-view display device. In particular, the image display apparatus 100 is characterized in that it uses video representation in which the virtual inclined angle of the floating image is changed in accordance with the relative positional relation between the predetermined spot in the direct-view image and the intersection line of the image formation surface and the display surface of the direct-view display device.

As shown in FIG. 21(a) to FIG. 21(c), in this aspect, it is assumed that the image display apparatus 100 is, for example, a car navigation which displays the position of a vehicle travelling as the map image. The basic structure thereof is the same as that of the image display apparatus 100 explained with reference to FIG. 17(a) to FIG. 17(c), and thus its explanation will be omitted.

The operation of the image display apparatus 100 constructed in this manner will be explained in line with FIG. 22, with reference to FIG. 21(a) to FIG. 21(c) as occasion demands.

In FIG. 22, firstly, a direct-view image 356 which indicates self-car surroundings is updated regularly or irregularly with the travel of the vehicle (step S401). Then, the position of the spot in the direct-view image 356 which indicates the self-car surroundings is detected by the control device 5 (step S402). The spot herein is, for example, a crossing and a destination. Then, it is judged whether or not the detected position of the spot is in the floating image display range (step 5403).

Here, if it is beyond the floating image display range (the step S403: NO), the floating image corresponding to the spot is not displayed (step S407).

On the other hand, if it is in the floating image display range (the step S403: YES), as shown in FIG. 21(a), a floating image 217 which indicates spot surroundings and a floating image 218 which indicates the travelling direction are displayed. The following process is performed to change the viewpoint (i.e. view) from which the floating images displayed at this time are viewed and the virtual inclined angle, in accordance with the difference in position between the intersection line 2135 and the spot.

Firstly, the difference in position between the intersection line 2135 and the spot in the direct-view image 356 which indicates the self-car surroundings is calculated (step S404).

Then, it is judged whether or not the calculated difference in position is less than or equal to a predetermined driver's view distance (step S405). The “driver's view distance” herein is a reference distance when it is judged whether the floating image 217 which indicates the spot surroundings is to be displayed in the driver's view or in a normal view. The “driver's view” is a viewpoint to obliquely look down the travelling direction from the above. According to this viewpoint, since the self-car position and the travelling direction can be accurately confirmed from the high viewpoint, it is easy to recognize an image of the self-car position surroundings. Hence, it is useful in displaying a relatively close place. The “normal view” is a viewpoint to look down the self-cal position from directly above. According to this viewpoint, it is possible to clearly distinguish between a road and a building by schematically displaying them. Hence, it is useful in displaying a relatively far place.

Here, if the calculated difference in position is greater than the predetermined driver's view distance (the step 5405: NO), the self-car position is still relatively far from the spot, so that the floating image 217 which indicates the spot surroundings and the floating image 218 which indicates the travelling direction are displayed in the normal view as shown in FIG. 21(a) (step S4061).

On the other hand, if the calculated difference in position is less than or equal to the predetermined driver's view distance (the step 5405: YES), the self-car position is relatively close to the spot, so that the floating image 217 which indicates the spot surroundings is displayed in the driver's view as shown in FIG. 21(b) and FIG. 21(c) (step S4062).

In the display in the driver's view, in particular, as shown in FIG. 21(b), the virtual inclined angles of the floating image 217 which indicates the spot surroundings and the floating image 218 which indicates the travelling direction are increased step-by-step and are fallen down visually, to be substantially parallel to the screen of the direct-view display device 35 (step S40721). Then, the floating image 217 which indicates the spot surroundings and the floating image 218 which indicates the travelling direction are brought closer to the direct-view display device 35 step-by-step.

In parallel with this, the direct-view image displayed by the direct-view display device 35 is changed step-by-step from the direct-view image 356 which indicates the self-car surroundings as shown in FIG. 21(a) and FIG. 21(1)) to a direct-view image 357 which indicates spot surroundings as shown in FIG. 21(c) (step S40722). At this time, on the direct-view display device 35, while the direct-view image 357 which indicates the spot surroundings is superimposed on the direct-view image 356 which indicates the self-car surroundings, the transparency of the direct-view image 357 which indicates the spot surroundings may be reduced step-by-step, or enlarged display may be performed step-by-step from the direct-view image 356 which indicates the self-car surroundings to the direct-view image 357 which indicates the spot surroundings. In addition, if the shadow of the floating image 218 which indicates the travelling direction is displayed as the direct-view image, the transition of the floating image 217 which indicates the spot surroundings from the floating image eventually to the direct-view image is expressed better without a sense of discomfort.

At this time, as shown in FIG. 21(c), the floating image 217 which indicates the spot surroundings is changed from the floating image to the direct-view image and is eventually not displayed. In contrast, the floating image 218 which indicates the travelling direction is preferably left as the floating image because the travelling direction is easily understood.

As explained in line with FIG. 22, with reference to FIG. 21(a) to FIG. 21(c) as occasion demands, according to the image display apparatus 100 in the aspect, such an interactive system is realized that the direct-view image and the floating image are changed in conjunction with each other in accordance with the relative positional relation between the intersection line 2135 and the predetermined spot in the floating image and the direct-view image.

In addition, such presentation that a certain image moves back and forth between the direct-view image and the floating image can be expressed more effectively by setting the various effects such as the virtual inclined angle, the transparency, the scaling ratio, and the shadow.

### (3-4) Fourth Aspect

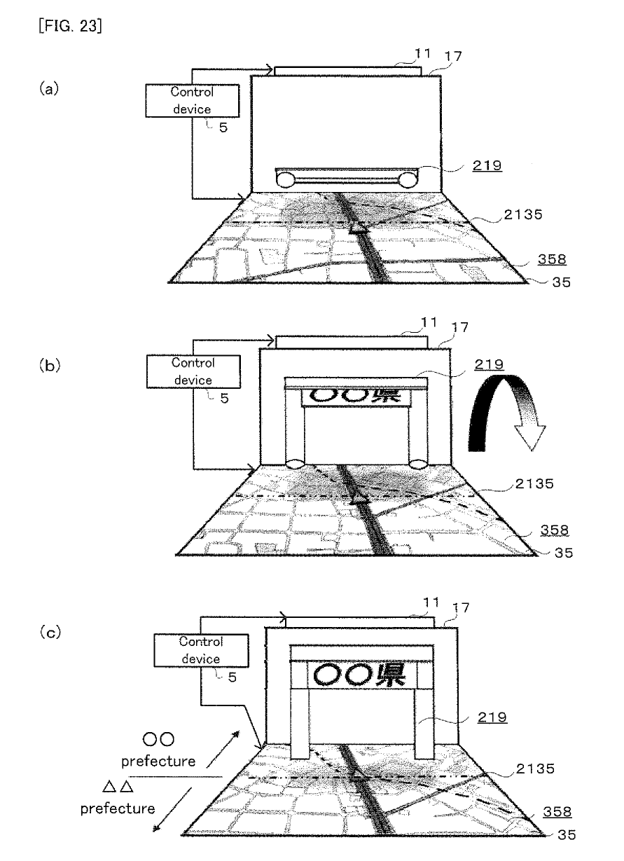

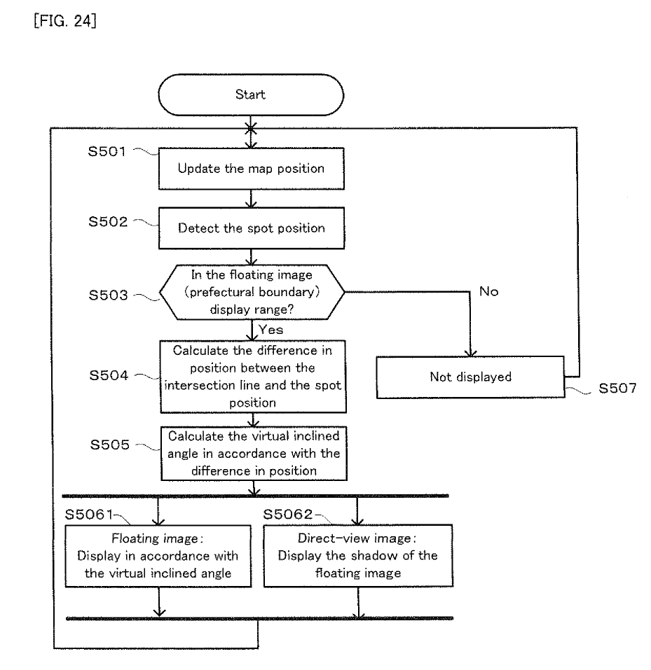

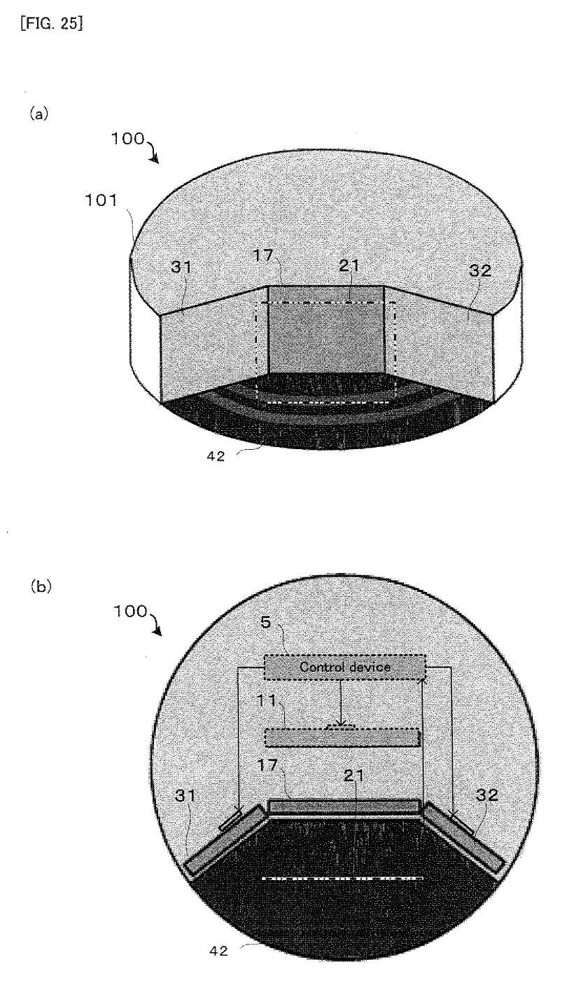

Next, a fourth aspect of the image display apparatus in the embodiment will be explained in line with FIG. 24, with reference to FIG. 23(a) to FIG. 23(c) as occasion demands. FIG. 23 are schematic diagrams showing that the floating image and the direct-view image change in conjunction with each other (a: first state, b. second state, c: third state). FIG. 24 is a flowchart showing a process in which the floating image and the direct-view image change in conjunction with each other.

The image display apparatus 100 in the aspect is characterized in that it improves the expressiveness by dynamically changing the floating image or the direct-view image in accordance with the relative positional relation between the predetermined spot in the floating image and the direct-view image and the intersection line of the image formation surface and the display surface of the direct-view display device. In particular, the image display apparatus 100 is characterized in that it uses video representation in which the virtual inclined angle of the floating image is changed in accordance with the relative positional relation between the predetermined spot in the direct-view image and the intersection line of the image formation surface and the display surface of the direct-view display device.

As shown in FIG. 23(a) to FIG. 23(c), in this aspect, it is assumed that the image display apparatus 100 is, for example, a car navigation which displays the position of a vehicle travelling as the map image. The basic structure thereof is the same as that of the image display apparatus 100 explained with reference to FIG. 17(a) to FIG. 17(c), and thus its explanation will be omitted.

The operation of the image display apparatus 100 constructed in this manner will be explained in line with FIG. 24, with reference to FIG. 23(a) to FIG. 23(c) as occasion demands.

In FIG. 24, firstly, a direct-view image 358 which indicates self-car surroundings is updated regularly or irregularly with the travel of the vehicle (step S501). Then, the position of the spot in the direct-view image 358 which indicates the self-car surroundings is detected by the control device 5 (step S502). The spot herein is, for example, a prefectural boundary. Then, it is judged whether or not the detected position of the spot is in the floating image display range (step S503).

Here, if it is beyond the floating image display range (the step S503: NO), a floating image 219 which displays a prefectural boundary guidance corresponding to the spot is not displayed (step S507).

On the other hand, if it is in the floating image display range (the step S503: YES), as shown in FIG. 23(a), the floating image 219 which displays the prefectural boundary guidance is displayed. If the floating image 219 which displays the prefectural boundary guidance has just entered in the floating image display range, the floating image 219 which displays the prefectural boundary guidance is displaced such that it looks like being in a substantially parallel state to the screen of the direct-view display device 35, in other words, it looks falling down, for the user. Then, the following process is performed to change the virtual inclined angle of the floating image 219 which displays the prefectural boundary guidance, in accordance with the difference in position between the intersection line 2135 and the prefectural boundary, which is the spot.

Firstly, the difference in position between the intersection line 2135 and prefectural boundary, which is the spot, is calculated (step S504). Then, the virtual inclined angle is calculated in accordance with the calculated difference in position (step S505).

Then, the floating image 219 which displays the prefectural boundary guidance is displayed in accordance with the calculated virtual inclined angle (step S5061). For example, as shown in FIG. 23(b), by setting the virtual inclined angle to be smaller as the calculated difference in position becomes smaller, the floating image 219 which displays the prefectural boundary guidance looks like rising up as the self-car approaches the prefectural boundary. Then, as shown in FIG. 23(c), when the calculated difference in position is zero, i.e. when the self-car matches the prefectural boundary, the floating image 219 which displays the prefectural boundary guidance stands erect and provides a guidance of the prefectural boundary.

In parallel with this, in the direct-view image 358 which is displayed by the direct-view display device 35 and which indicates the self-car surroundings, the shadow of the floating image 219 which displays the prefectural boundary guidance is displayed as the direct-view image (step S5062). The shadow may be displayed to approach step-by-step from the rear of the intersection line 2135 toward the intersection line 2135, in accordance with the virtual inclined angle of the floating image 219 which displays the prefectural boundary guidance.

As explained in line with FIG. 24 with reference to FIG. 23a) to FIG. 23c) as occasion demands, according to the image display apparatus 100 in the aspect, such an interactive system is realized that the direct-view image and the floating image are changed in conjunction with each other in accordance with the relative positional relation between the intersection line 2135 and the predetermined spot in the floating image and the direct-view image.

In addition, it is possible to express a sense of distance between the floating image and the intersection line 2135 more effectively by setting the various effects such as the virtual inclined angle, the transparency, the scaling ratio, and the shadow.

Incidentally, in the second to fourth aspects of the third embodiment, such a rendering effect is provided that the floating image falls down or rises up; however, this is video representation performed in the floating image displayed on the image formation surface, and the image formation surface itself does not fall down nor rise up.

### (4) FOURTH EMBODIMENT

Next, an image display apparatus in a fourth embodiment will be explained with reference to FIG. 25 to FIG. 31. Incidentally, the same constituents in the aforementioned first to third embodiments carry the same reference numerals, and their explanation will be omitted as occasion demands.

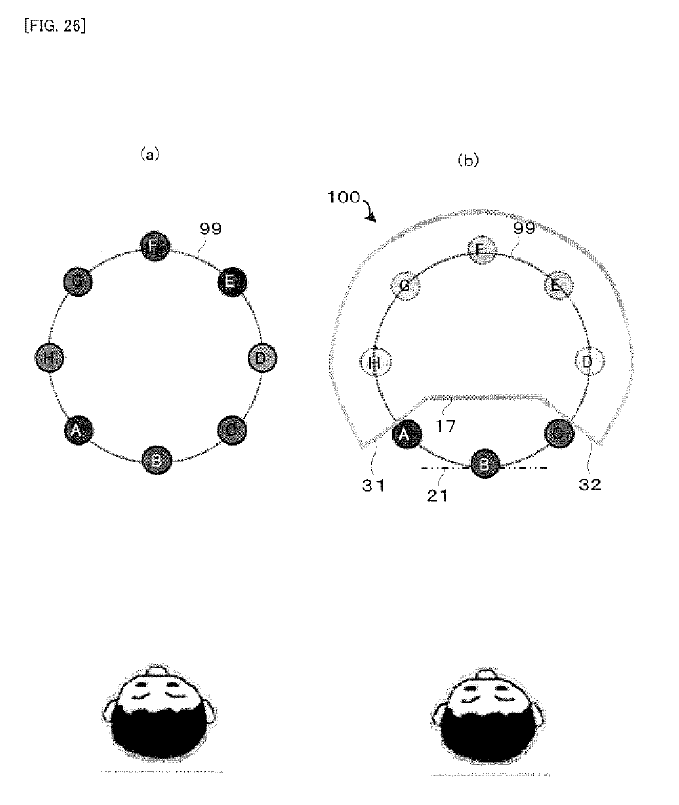

The image display apparatus in the embodiment has an interface in which the direct-view image and the floating image are combined. Then, icons arranged in a predetermined manner on a virtual space are expressed with the images. The situation will be detailed below using FIG. 25 and FIG. 26. FIG. 25 are schematic diagrams showing the overall structure of the image display apparatus in a circular shape which can be displayed by combining the floating image and the direct-view image (a: perspective view, b: top view). FIG. 26 are top views showing a plurality of icons circularly arranged (a: virtual arrangement drawing, b: actual arrangement drawing).

As shown in FIG. 25(a) and FIG. 25(b), the image display apparatus 100 in the embodiment is provided with the case 101, the direct-view display device 31, the direct-view display device 32, the image transmission panel 17, the display device 11, the control device 5, and a position detection device 42.

In the embodiment, in particular, the case 101 is cylinder-shaped (whose cross section includes not only a precise circle but also an ellipse and the like). The position detection device 42 of a turntable type has a shape that follows the outline of the case 101, and it is located on the bottom surface of the case 101. If it is displaced in its circumferential direction, diameter direction, or perpendicular direction, the case 101 can transmit its operation information to the control device 5. If the image display apparatus 100 is designed into a circle as a whole, the following advantages can be obtained.

As shown in FIG. 26(a), for example, although eight icons A to H do not exist in real, it can be shown to the user such that the eight icons are arranged in a circle on the virtual space, i.e. on a first virtual route 99 in FIG. 26(a). Thus, as shown in FIG. 26(b), for example, the icons A and C located in front of the image display apparatus 100 are expressed by the direct-view images, and the icon B on the closest side viewed from the user is expressed by the floating image. Specifically, the icon A is displayed on the direct-view display device 31, the icon C is displayed on the direct-view display device 32, and the icon B is displayed on the image formation surface 21. At this time, the position of the floating image and the position of the direct-view images are preferably shifted in the depth direction viewed from the user because in that way, perspective is emphasized. In other words, it is possible to feel the image that the icons are arranged on the first virtual route 99, more realistically.

As described above, the three icons A to C are displayed to be located on the first virtual route 99 and the image display apparatus 100 itself is cylinder-shaped, so that for the user, it looks as if the following icons D to existed in the case 101.

Incidentally, there are the three icons displayed as the direct-view images and the floating image in the embodiment; however, the number of the icons may be greater than three or less than or equal to three. For example, even if there is only one icon displayed as the floating image, the same or similar effect can be obtained depending on the motion of the icon and the shape of the case 101.

Incidentally, the shape of the case 101 only needs to match that of the first virtual route 99, and it is not limited to the circular shape. For example, it may be oval or polygonal. However, if the operation of rotating the icons arranged as described later is adopted, the shape of the cross section of the case 101. is desirably symmetric with respect to the center of rotation.

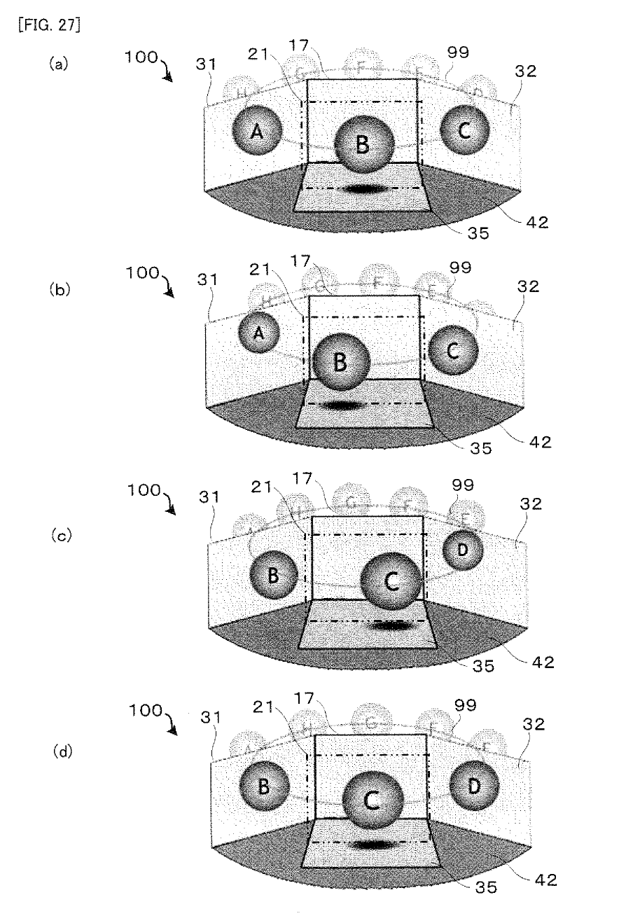

Next, with reference to FIG. 27(a) to FIG. 27(d), an explanation will be given on the operation that the icons A to H arranged on the first virtual route 99 are rotated on the image display apparatus 100 constructed in the above manner. FIG. 27 are schematic diagrams showing the rotational transfer of the plurality of icons circularly arranged (a: first state, b. second state, c: third state, d: fourth state).

As shown in FIG. 27(a) to FIG. 27(d), according to the image display apparatus 100 in the embodiment, for example, by rotating the position detection device 42 of the turntable type, it looks like the icons hidden inside the case 101 of the icons A to H arranged on the first virtual route 99 appear from the rear to the front side. Alternatively, it looks like the icons located in front enter inside the case 101.

More specifically, firstly, as shown in FIG. 27(a), the icons A to H are arranged on the first virtual route 99. Among them, the icon A is displayed as the direct-view image on the direct-view display device 31, the icon B as the floating image on the image formation surface 21, and the icon C as the direct-view image on the direct-view display device 31. In addition, the shadow of the icon B as the floating image may be displayed as the direct-view image on the direct-view display device 35. For example, the turntable may be formed of a light transmissive material, and the direct-view display device 35 is disposed under the turntable. Thus, the direct-view image on the direct-view display device 35 can be seen over the turntable.

Then, as shown in FIG. 27(b), for example, by rotating the position detection device 42 of the turntable type, the arrangement of the icons A to H is changed along the first virtual route 99. Specifically, if the position detection device 42 is rotated to the left, each of the icons A to C is displayed to be rotated and displaced to the left. With this, the shadow of the icon B displayed on the direct-view display device 35 as the direct-view image is also displaced to the left.

Then, as shown in FIG. 27(c), for example, by further rotating the position detection device 42, the arrangement of the icons A to H is changed along the first virtual route 99. Specifically, the icon A is hidden inside the case 101 and is not displayed on the direct-view display device 31. The icon B is changed from the floating image displayed on the image formation surface 21 to the direct-view image displayed on the direct-view display device 31. The icon C is changed from direct-view image displayed on the direct-view display device 32 to the floating image displayed on the image formation surface 21. The icon D is displayed on the direct-view display device 32 as if it pops up from the inside of the case 101.

Then, as shown in FIG. 27(d), by further rotating the position detection device 42, the arrangement of the icons A to H is further changed along the first virtual route 99.

Eventually, it looks like the icons A to C shown in FIG. 27(a) are only replaced by the icons B to D shown in FIG. 27(d); however, it looks as if not only the icons A to C but also the other not-illustrated icons D to H were rotated and displaced along the first virtual route 99 due to the series of change shown in FIG. 27(a) to FIG. 27(d). Incidentally, the rotated and displaced ions A to H may be looped. In other words, the position detection device 42 may loop back after being further rotated and displaced. The loop further emphasizes that the icons A to H are arranged on the first virtual route 99.

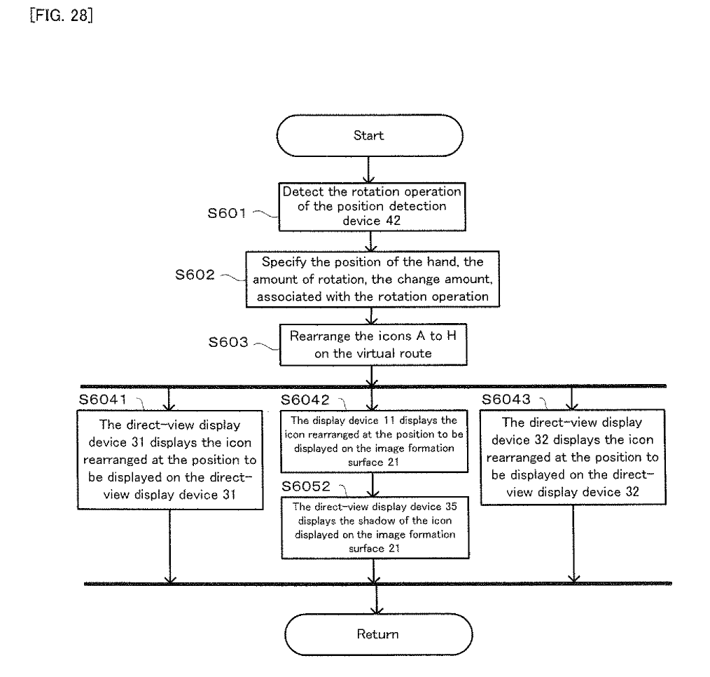

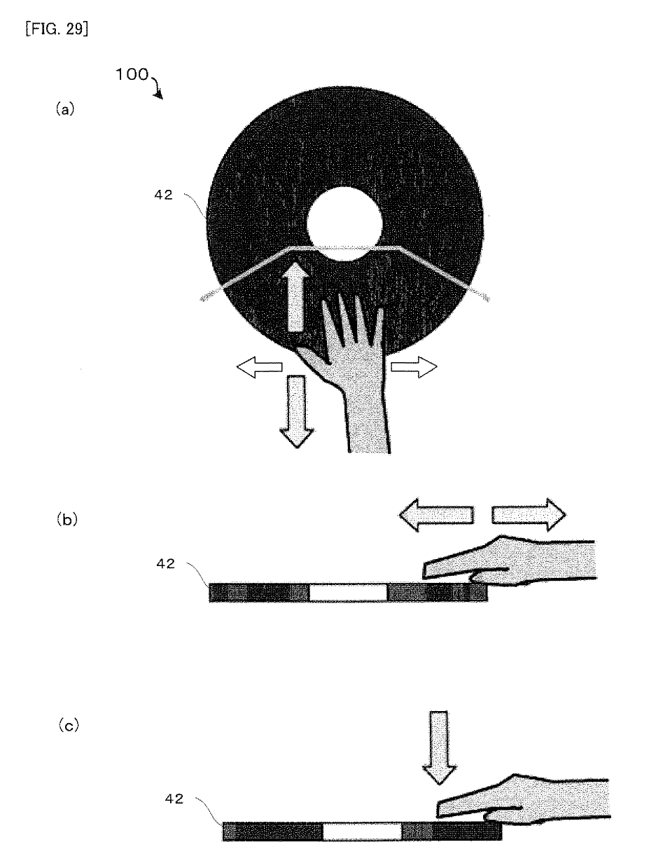

The operation example explained with reference to FIG. 27(a) to FIG. 27(d) will be explained in line with a flowchart shown in FIG. 28. FIG. 28 is a flowchart showing a process associated to the rotational transfer of the plurality of icons circularly arranged.

In FIG. 28, firstly, the rotation operation is detected by the position detection device 42, and it is transmitted as an electrical signal to the control device 5 (step 8601). The control device 5 specifics the position of the hand, the change amount, or the amount of rotation associated with the rotation operation, on the basis of the transmitted signal (step 8602). On the basis of the specified result, the control device 5 rearranges the icons A to H on the first virtual route 99 (step 8603). In other words, it recalculates the coordinates of the icons A to H on the first virtual route 99.

Then, as described below, the icons A to H are displayed as the direct-view images or the floating image, using the coordinates after rearrangement. Firstly, the control device 5 controls the direct-view display device 31 to display the icon rearranged at the position to be displayed as the direct-view image on the direct-view display device 31 (step S6041). In the same manner, the control device 5 controls the direct-view display device 32 to display the icon rearranged at the position to be displayed as the direct-view image on the direct-view display device 32 (step S6043). Simultaneously with or in tandem with this, the control device 5 controls the display device 11 to display the icon rearranged at the position to be displayed as the floating image on the display device 11 (step S6042). In addition, the control device 5 controls the direct-view display device 35 to display the shadow of the icon displayed on the image formation surface 21, as the direct-view image (step S6052).

As described above, the icons A to H arranged on the first virtual route 99 are rotated on the image display apparatus 100.

By the way, in the aforementioned embodiments, the position detection device 42 of the turntable type is illustrated as the position detection device; however, the position detection device 42 may adopt other various aspects if the user can operate it with respect to the image display apparatus 100. For example, a space sensor, a touch panel, or a rotating controller such as the turntable are the candidates.

If the space sensor which uses ultrasound or an imaging element or the like is adopted as the position detection device as described with reference to FIG. 7, the icons A to H are rotated and selected in the following manner; namely, the rotation operation is realized by moving the hand in a direction along the first virtual route 99 in the detectable range of the space sensor. On the other hand, the selection operation is realized by moving the hand in a direction crossing the first virtual route 99 in the detectable range of the space sensor. Alternatively, the following manner may be also adopted; namely, the rotation operation is realized by moving the hand in the direction along the first virtual route 99, in the detectable range of the space sensor and in the space that the floating image is not displayed. On the other hand, the selection operation is realized by the user touching the floating image in the detectable range of the space sensor.

Alternatively, if the touch panel is adopted as the position detection device as described with reference to FIG. 9, the icons A to H are rotated and selected in the following manner; namely, the rotation operation is realized by moving the hand in the direction along the first virtual route 99 on the touch panel. On the other hand, the selection operation is realized by moving the hand in the direction crossing the first virtual route 99 on the touch panel. Alternatively, if the touch panel is attached to the screen of the direct-view display device 35, the following manner may be adopted; namely, the rotation operation is realized by moving the finger on the touch panel so as to displace a scroll bar or a slide bar displayed on the screen. On the other hand, the selection operation is realized by moving the finger on the touch panel so as to press a selection button displayed on the screen.

Alternatively, as explained with reference to FIG. 29(a) to FIG. 29(c), if the position detection device 42 of the turntable type, which is one example of the rotating controller, is adopted as the position detection device 42, the icons A to H are rotated and selected in the following manner. FIG. 29 are schematic diagrams showing the basic structure of the turntable.

As shown in FIG. 29(a), the rotation operation is realized by rotating the position detection device 42 of the turntable type in the circumferential direction. On the other hand, as shown in FIG. 29(b), the selection operation is realized by sliding the position detection device 42 of the turntable type in the diameter direction. For example, if the position detection device 42 of the turntable type is pushed in the diameter direction, an item corresponding to the icon displayed as the floating image at that time is selected, and the screen is transferred to the next screen corresponding to the selected item. On the other hand, if the position detection device 42 of the turntable type is pulled in the diameter direction, it may go back to the original screen. Alternatively, as shown in FIG. 29(c), the selection operation may be realized by pressing the position detection device 42 of the turntable type from the above. In addition, by combining the operation of rotating the position detection device 42 of the turntable type in the circumferential direction and the operation of sliding it in the diameter direction, an operational feeling similar to drag may be realized. For example, by pressing the position detection device 42 of the turntable type into the diameter direction, a volume icon may be selected which indicates the volume of a sound source and which is built in the image display apparatus 100. Then, the volume may be increased or reduced by rotating the position detection device 42 in the right or left circumferential direction with it pressed, and the volume may be determined by releasing the pressed state.

Incidentally, as shown in FIG. 29(a) to FIG. 29(c), if the amount of the user moving the hand, or the amount of rotation of the table is detected by the position detection device 42, the control device 5 preferably controls the display device 11 and the direct-view display devices such that the detection amount is equal to or proportional to the amount of displacement or the amount of rotation of each of the icons A to H as shown in FIG. 27(a) to FIG. 27(d). As described above, by linking the motion of the user to the display content, reality in terms of presentation is further increased.

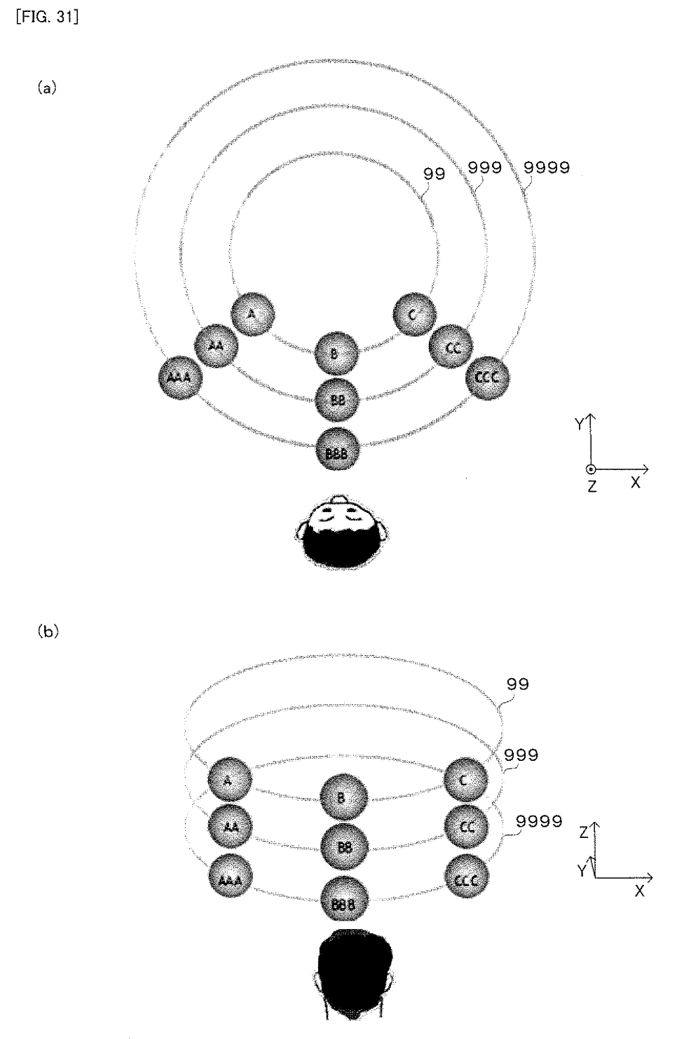

Incidentally, in the image display apparatus 100 in the embodiment, the relation in the number and arrangement of the floating image and the direct-view image is not limited to the aspect that the three icons are represented by one floating image and two direct-view images, as shown in FIG. 30(a). For example, as shown in FIG. 30(b), all the three icons may be represented by the floating images. Here, FIG. 30 are schematic diagrams showing the icons represented by the floating image and the direct-view image (a: one floating image and two direct-view images, b: three floating images).

In FIG. 30(b), the image display apparatus 100 is further provided with image transmission panels 171 and 172, in addition to the image transmission panel 17. On the back surface of each image transmission panel, a display device (not illustrated) for displaying an image which is the origin of the floating image is disposed. Moreover, the display light which constitutes the image displayed on each display device is transmitted to the corresponding image transmission panel, and then, the floating images are displayed on the image formation surface 21 and image formation surfaces 2101 and 2102. At this time, the position of each floating image is preferably shifted in the depth direction viewed from the user because in that way, perspective is emphasized. At this time, the shadows of the floating images may be displayed on the direct-view display device 350 at the positions which correspond to the shift of the positions of the image formation surfaces.

Incidentally, in order to express the transition in the hierarchy of the icons by the aforementioned operation, as shown in FIG. 31(a) and FIG. 31(b), it is effective to display the icons such that a hierarchy structure can be visually recognized. FIG. 31 are schematic diagrams showing a virtual hierarchic structure of the icons (a: arranged concentrically, b: arranged in a multilayer disc shape).

In FIG. 31(a), the hierarchy of the icons is virtually expressed in a concentric shape. Specifically, the first virtual route 99, a second virtual route 999, and a third virtual route 9999 are set concentrically. Moreover, the icons A to C are displayed on the first virtual route 99, icons AA to CC are displayed on the second virtual route 999, and icons AAA to CCC are displayed on the third virtual route 9999. At this time, for example, each of the icons A, AA, AAA, C, CC, and CCC is displayed as the direct-view image, and each of the icons B, BB, and BBB is displayed as the floating image. Incidentally, a group of the icons B, BB, and BBB may be displayed on a plurality of image formation surfaces (e.g. three layers), or only the icon that belongs to the currently selected hierarchy (e.g. the icon BBB) may be displayed on one image formation surface. Since the icons are displayed concentrically as described above, the following operation can be performed; namely, for example, if the icon BB is displayed on the closest side as the floating image, the icon BB is the icon of a selection candidate. If the rotation operation is performed (e.g. if the position detection device 42 of the turntable type is rotated along the circumferential direction), the icon of the selection candidate is changed to the icon AA or the icon CC. Alternatively, if the displacement operation is performed, it is transited to another hierarchy. For example, if the position detection device 42 of the turntable type is pulled in the diameter direction, the virtual route to which the icon of the selection candidate belongs is changed from the second virtual route 999 to the first virtual route 99. On the other hand, if the position detection device 42 of the turntable type is pushed in the diameter direction, the virtual route to which the icon of the selection candidate belongs is changed from the second virtual route 999 to the third virtual route 9999. In transferring the hierarchy as described above, such rendering can be performed that the new icon pops up from the central direction or the exterior of the concentric circle, or that it recedes into the concentric circle, by changing the scaling ratio of transparency of each icon, as occasion demands. Moreover, if the selection operation of selecting the icon BB is performed (e.g. if the position detection device 42 of the turntable type is pressed from the above) while the third virtual route 9999 is displayed, the display of contents related to the selected icon BBB is started.

Alternatively, in FIG. 31(b), the hierarchy of the icons is virtually expressed in a multilayer shape. Specifically, the first virtual route 99, the second virtual route 999, and the third virtual route 9999 are set in a multilayer shape. This type of setting allows such presentation that each virtual route drops away or goes up as a whole, in addition to or instead of the selection operation, the rotation operation, and the displacement operation described above.

Incidentally, the concentric virtual route may be set in a multilayer shape. This can result in the more spatial presentation.

Incidentally, in the aforementioned embodiments, if the touch panel or the turntable is applied as the position detection device, several other merits can be also considered, compared to the case of the space sensor. For example, typically, the operation is performed with the hand placed under the floating image, so that the operation can be performed without the floating image hidden by the hand. Moreover, new excitement can be felt which is different from when the floating image is directly touched and operated as in the space sensor. Moreover, for example, when it is used in a vehicle or in similar cases, there is such a merit that the operation can be performed stably because the hand is on a real object, compared to a more or less unstable situation that the hand is extended into the space.

Incidentally, the present invention is not limited to the aforementioned embodiments, but may be changed, if necessary, without departing from the scope or idea of the invention, which can be read from all the claims and the specification thereof. The image display apparatus with such a change is also included in the technical scope of the present invention.

### INDUSTRIAL APPLICABILITY

The image display apparatus of the present invention can be applied to an image display apparatus for stereoscopically displaying the two-dimensional image on the basis of the 3D floating vision method, for example.

1-12. (canceled)

13. An image display apparatus comprising:
a plurality of first displaying devices for displaying a first image on a first screen;
a plurality of image transmitting devices which is disposed on an optical path of display light which constitutes the first image and which transmits the display light which constitutes the first image so as to display a real image of the first image as a floating image on an image formation surface located in a space on an opposite side to the first screen; and
a controlling device for controlling said plurality of first displaying devices such that at least one of a plurality of icons is displayed as a floating image disposed along a virtual route in a predetermined shape set in a real space portion including the space, wherein
a plurality of the image formation surfaces are formed due to said plurality of first displaying devices and said plurality of image transmitting devices,
each of the plurality of image formation surfaces has mutually different positions in a depth direction with respect to a user of said display image apparatus, and
said controlling device controls said first displaying device such that the at least one of the plurality of icons is displaced on the virtual route if the at least one of the plurality of icons is displayed such that the at least one of the plurality of icons is displaced along the virtual route.

14. An image display apparatus comprising:
a first displaying device for displaying a first image on a first screen;
an image transmitting device which is disposed on an optical path of display light which constitutes the first image and which transmits the display light which constitutes the first image so as to display a real image of the first image as a floating image on an image formation surface located in a space on an opposite side to the first screen;
a controlling device for controlling said first displaying device such that at least one of a plurality of icons is displayed as a floating image disposed along a virtual route in a predetermined shape set in a real space portion including the space; and
a second displaying device for displaying a second image on a second screen as a direct-view image so as to be viewed from an observation position at which the floating image can be observed, wherein
said controlling device also controls said second displaying device in addition to said first displaying device such that another icon different from the icon displayed by said first displaying device is displayed as a direct-view image disposed along the virtual route.

15. The image display apparatus according to claim 13, wherein
said image display apparatus further comprises a position detecting device for outputting a position signal corresponding to a position of a detected object, and
said controlling device controls said plurality of first displaying devices to dispose the plurality of icons at positions corresponding to the position of the detected object.

16. The image display apparatus according to claim 13, wherein at least three icons of the plurality of icons are each displayed as the floating image.

17. The image display apparatus according to claim 13, wherein the plurality of icons are displayed in a loop along the virtual route.

18. The image display apparatus according to claim 13, wherein there are a plurality of virtual routes, and each of the virtual routes is disposed in a concentric shape or in a multilayer shape.

19. The image display apparatus according to claim 13, wherein the virtual route is circular.

20. The image display apparatus according to claim 13, wherein a shape of a case of said image display apparatus at least partially matches that of the virtual route.

21. The image display apparatus according to claim 14, wherein
said image display apparatus further comprises a position detecting device for outputting a position signal corresponding to a position of a detected object, and
said controlling device controls at least one of said first displaying device and said second displaying device to dispose the plurality of icons at positions corresponding to the position of the detected object.

22. The image display apparatus according to claim 14, wherein at least three icons of the plurality of icons are each displayed as the floating image or the direct-view image.

23. The image display apparatus according to claim 14, wherein the second screen or the image formation surface in which the plurality of icons are displayed has mutually different positions in a depth direction with respect to a user of said display image apparatus.

24. The image display apparatus according to claim 21, wherein said position detecting device outputs the position signal if the position of the detected object is displaced along the virtual route.

25. The image display apparatus according to claim 21, wherein said position detecting device comprises one or a plurality of operation buttons, and when any of the one or the plurality of operation buttons is pressed by the detected object, said position detecting device outputs a signal corresponding to the pressed operation button as the position signal.

26. The image display apparatus according to claim 21, wherein
said image display apparatus further comprises a communicating device for communicating with another apparatus, and
said communicating device communicates with the another apparatus such that the another apparatus operates on the outputted position signal.

27. The image display apparatus according to claim 24, wherein
said image display apparatus further comprises a communicating device for communicating with another apparatus, and
said communicating device communicates with the another apparatus such that the another apparatus operates on the outputted position signal.

28. The image display apparatus according to claim 25, wherein
said image display apparatus further comprises a communicating device for communicating with another apparatus, and
said communicating device communicates with the another apparatus such that the another apparatus operates on the outputted position signal.

29. The image display apparatus according to claim 14, wherein the plurality of icons are displayed in a loop along the virtual route.

30. The image display apparatus according to claim 14, wherein there are a plurality of virtual routes, and each of the virtual routes is disposed in a concentric shape or in a multilayer shape.

31. The image display apparatus according to claim 14, wherein the virtual route is circular.

32. The image display apparatus according to claim 14, wherein a shape of a case of said image display apparatus at least partially matches that of the virtual route.
